(19) United States
(12) Patent Application Publication
(10) Pub. No.: US 2026/0279352 A1
(43) Pub. Date: Sep. 17, 2026

(54) SYSTEM

(71) Applicant: SoftBank Group Corp., Tokyo (JP)

(72) Inventor: Takeshi ABE, Tokyo (JP)

(73) Assignee: SoftBank Group Corp., Tokyo (JP)

(21) Appl. No.: 19/553,585

(22) Filed: Mar. 2, 2026

Related U.S. Application Data
(60) Provisional application No. 63/770,060, filed on Mar. 11, 2025.

(51) Int. Cl. G10L 15/22; G06F 16/3329; G06F 16/335; G10L 25/63

(52) U.S. Cl. CPC G10L 15/22; G06F 16/33295; G06F 16/337; G10L 25/63

(57) ABSTRACT

A system includes a processor configured to acquire surrounding conversation in real time via a microphone and generate corresponding audio data. The processor converts the audio data into text using a speech recognition engine and analyzes the text using a natural language processing engine to extract at least a conversation theme, emotion, and intention. The processor accesses a user profile database including interests, concerns, conversation history, and personality traits, and generates conversation topics using a machine learning or rule-based model based on the analysis result and user profile information. The processor monitors conversation flow to determine a timing to introduce the generated topics and converts the topics into synthesized speech for output from a device worn by the user.

### CROSS-REFERENCE TO RELATED APPLICATION

This application claims the benefit of U.S. Provisional Application No. 63/770,060 filed on Mar. 11, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional conversation support systems and general-purpose dialogue agents are not well suited for assisting a user in real-time, face-to-face social situations, such as networking events, meetings, or casual gatherings. Existing technologies typically provide static topic suggestions, canned phrases, or generic chat functions that are not synchronized with the actual flow of an ongoing conversation around the user. As a result, the user often receives suggestions that are untimely, contextually inappropriate, or not aligned with the user's personal interests and personality traits. In particular, users who are shy, introverted, or anxious about social interaction face significant psychological barriers to participating in conversations, because they must simultaneously track the conversation content, infer suitable topics, and decide when to speak. Furthermore, known systems generally lack an integrated mechanism that (i) captures surrounding speech in real time, (ii) converts the speech into text, (iii) analyzes the conversation theme, emotion, and intention, (iv) cross-references this analysis with a dynamically updated user profile, (v) generates personalized conversation topics, and (vi) determines an appropriate timing for interrupting the conversation and presenting synthesized speech suggestions to the user. Accordingly, there is a need for a system that holistically performs these operations so that the user can naturally and smoothly participate in real-world conversations with reduced cognitive and psychological burden.

### SUMMARY

In order to solve the foregoing problems, an embodiment of the present invention provides a system comprising a processor, wherein the processor is configured to control an audio input unit including a microphone to acquire surrounding conversation in real time and to generate audio data corresponding to the surrounding conversation, control a speech recognition unit including a speech recognition engine to convert the audio data acquired by the audio input unit into text data, control a natural language processing unit including a natural language processing engine to analyze the text data and to extract at least a conversation theme, an emotion, and an intention, and control a user profile management unit to manage a profile database including, for a user, at least interests, concerns, past conversation history, and personality traits. The processor is further configured to control a conversation generation unit including at least one of a machine learning model and a rule-based model to generate conversation topics based on an analysis result from the natural language processing unit and user profile information from the user profile management unit, control a timing control unit to monitor a flow of the conversation and to determine, based on the monitored flow, a timing at which the system interrupts the conversation with the generated conversation topics, and control a speech synthesis unit including a speech synthesis engine to convert the generated conversation topics into synthesized speech and to cause the synthesized speech to be output from a device worn by the user. In one embodiment, the processor controls the speech recognition unit to process, in real time, the audio data acquired by the audio input unit, and controls the natural language processing unit to analyze, with high accuracy, at least the conversation theme and the emotion so that the conversation generation unit generates conversation topics that are likely to be of interest to the user. In addition, the processor controls the user profile management unit to learn changes in the interests and concerns of the user and to dynamically update the profile database, and controls the conversation generation unit to generate conversation topics based on most recent user information stored in the profile database. In another embodiment, the processor controls the timing control unit to monitor, in real time, the flow of the conversation and to optimize, when the conversation reaches a pause or when a specific keyword appears, a timing at which the generated conversation topics are output via the speech synthesis unit, and further controls the timing control unit to detect at least silence between utterances and changes in tone in the conversation and, in consideration of the detected silence and changes in tone, execute an algorithm that allows the user to participate in the conversation naturally. Through this integrated configuration, the system provides personalized, context-aware, and well-timed conversational support that lowers the psychological barrier for the user and promotes smoother communication.

The term “processor” refers to a hardware and/or software computation element, such as a CPU, GPU, microcontroller, or a combination thereof, configured to execute instructions and to control the functional units of the system described in the claims.

The term “audio input unit” refers to a hardware and/or software component configured to capture sound from an environment surrounding a user and to output corresponding audio data to other components of the system.

The term “microphone” refers to a transducer included in the audio input unit that converts acoustic sound waves in the surrounding environment into electrical signals or digital audio data.

The term “audio data” refers to data representing sound captured by the audio input unit, including but not limited to digitized waveforms suitable for processing by a speech recognition engine.

The term “speech recognition unit” refers to a hardware and/or software component, including a speech recognition engine, configured to convert audio data into text data by analyzing acoustic features and applying language models.

The term “speech recognition engine” refers to a software module or set of algorithms that processes audio data, extracts acoustic and phonetic features, and outputs corresponding text data with optional timing and confidence information.

The term “text data” refers to character-based or token-based data representing linguistic content derived from audio data, including words, sentences, or other textual units.

The term “natural language processing unit” refers to a hardware and/or software component, including a natural language processing engine, configured to analyze text data and to extract semantic, syntactic, and pragmatic information such as topics, emotions, and intentions.

The term “natural language processing engine” refers to a software module or set of algorithms that performs at least one of morphological analysis, syntactic parsing, semantic analysis, topic extraction, sentiment analysis, and intent detection on text data.

The term “conversation theme” refers to a main subject matter or topic of an ongoing conversation, such as travel, sports, work, technology, or other semantic domains identifiable from the text data.

The term “emotion” refers to an estimated affective state inferred from the conversation, such as positive, negative, neutral, excited, calm, anxious, or other emotional categories derived from the text data.

The term “intention” refers to a communicative purpose or goal of an utterance in the conversation, such as asking a question, providing information, making a suggestion, changing a topic, or closing a conversation.

The term “user profile management unit” refers to a hardware and/or software component configured to store, retrieve, and update user-related information in a profile database, including interests, concerns, past conversation history, and personality traits.

The term “profile database” refers to a data storage structure, implemented in one or more memory devices, that maintains user-specific information such as interests, concerns, past conversation records, personality traits, and parameters used for personalization.

The term “interests” refers to categories of topics, activities, or domains that are preferred or frequently engaged with by the user, such as hobbies, favorite subjects, or areas of curiosity, as stored in the profile database.

The term “concerns” refers to matters, themes, or issues that are of particular relevance or sensitivity to the user, including recurring topics the user cares about or wishes to avoid, as recorded in the profile database.

The term “past conversation history” refers to stored records or summaries of previous conversations involving the user, including topics, timestamps, and optionally system-generated suggestions used for personalization.

The term “personality traits” refers to attributes of the user's typical behavioral or communicative style, such as introversion, extroversion, preference for short utterances, or formality level, as represented in the profile database.

The term “conversation generation unit” refers to a hardware and/or software component, including at least one of a machine learning model and a rule-based model, configured to generate conversation topics or suggestion sentences based on analysis results and user profile information.

The term “machine learning model” refers to a computational model trained on data, such as a neural network or statistical model, that is configured to generate or select conversation topics or utterances based on input features derived from conversation analysis and user profiles.

The term “rule-based model” refers to a set of predefined rules, templates, or decision logic configured to generate or select conversation topics or utterances without requiring training on large datasets.

The term “conversation topics” refers to pieces of information, suggestions, or proposed subject matters, including specific sentences or phrases, that the system provides to facilitate or continue a conversation in which the user participates.

The term “timing control unit” refers to a hardware and/or software component configured to monitor the flow of an ongoing conversation and to determine a timing at which the system should interrupt or contribute to the conversation with generated conversation topics.

The term “flow of the conversation” refers to temporal and structural characteristics of an ongoing dialogue, including turn-taking patterns, pauses, topic transitions, and changes in tone or intensity over time.

The term “interrupts the conversation” refers to the act of the system initiating or prompting an utterance, via the user's device, at an appropriate point in the ongoing conversation so that a generated conversation topic can be introduced.

The term “speech synthesis unit” refers to a hardware and/or software component, including a speech synthesis engine, configured to convert text representing conversation topics into synthesized speech signals.

The term “speech synthesis engine” refers to a software module or set of algorithms that transforms text input into audio data representing artificial, machine-generated speech with a specified voice, tone, and speaking rate.

The term “synthesized speech” refers to audio output generated by the speech synthesis engine from text data, which is intended to be played to the user through a device.

The term “device worn by the user” refers to a terminal or output apparatus that the user wears or carries on the body, such as a smartwatch, earphones, smart glasses, or a head-mounted display, and that is capable of outputting audio corresponding to synthesized speech.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

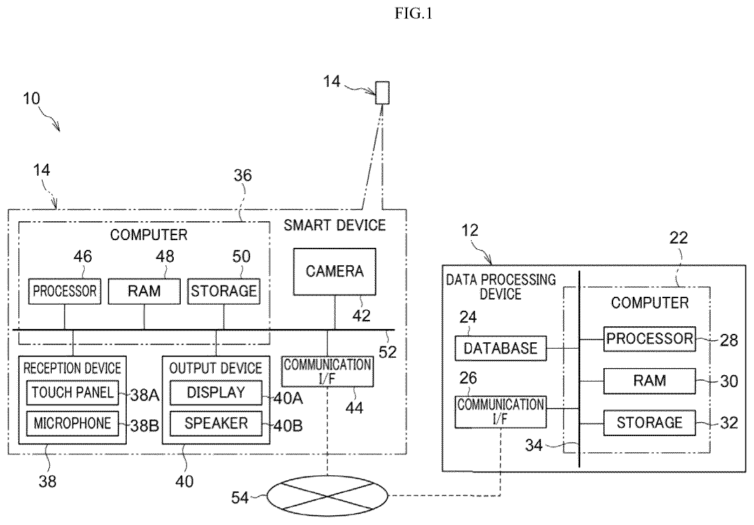

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

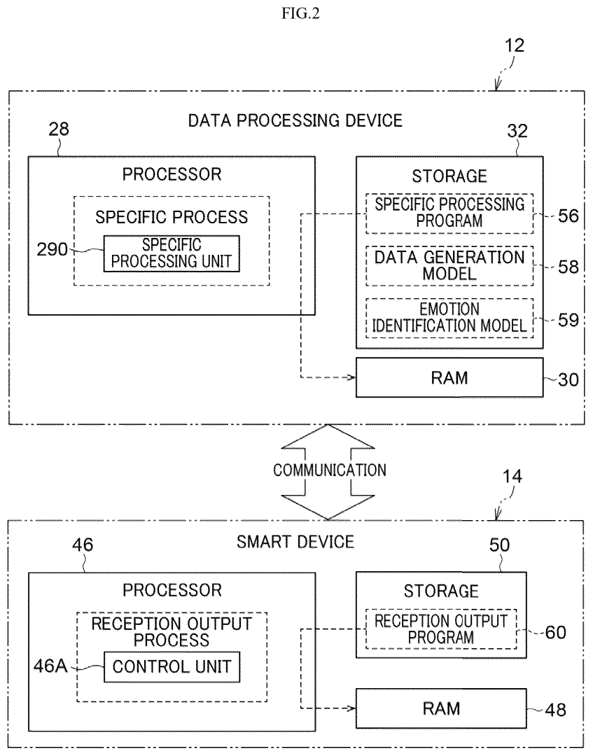

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional conversation support systems that rely on speech recognition and simple rule-based responses suffer from several technical limitations when deployed on general-purpose computing platforms. First, such systems typically treat audio acquisition, language understanding, user preference handling, and response generation as loosely coupled components, without a unified, context-aware control flow executed by a programmable processor. As a result, processing pipelines often exhibit high latency, unstable timing, and inconsistent behavior across varying acoustic environments and conversational dynamics, thereby degrading the performance of the underlying computer system in real-time interaction scenarios.

Second, traditional systems generally do not optimize internal data representations for the combined use of conversational context and user-specific information. For example, prior approaches may store user preferences and profile data as static records and may analyze conversation text only at a superficial level. These systems typically lack mechanisms to convert both conversation content and user profile information into structured vectors and similarity measures that can be processed efficiently by a processor for real-time decision-making. This leads to inefficient use of memory and compute resources, and it prevents scalable personalization in multi-user, multi-session environments.

Third, existing architectures often employ generative AI models or language models in an ad hoc manner, treating such models as black-box text generators without systematic construction of prompt sentences or structured context. Without a processor-controlled mechanism for assembling conversation transcripts, topic vectors, emotion vectors, and user interest vectors into a machine-readable context and then into a carefully constrained prompt sentence, the output of the generative AI model can be unstable, off-topic, or computationally wasteful. This results in unnecessary processing cycles, redundant network calls, and reduced throughput on shared computing infrastructure.

Fourth, timing control in many prior art systems is either manual or based on simple thresholds that do not fully exploit the rich temporal and semantic signals available from conversation audio and transcripts. Typical implementations may merely detect pauses or count words, without systematically combining silence duration, utterance length, utterance frequency, emotion score variations, and specific term occurrences into a conversation state classification. Consequently, processors in these systems cannot reliably determine optimal intervention times, leading to either missed opportunities for assistance or disruptive interruptions, and thereby reducing the effectiveness and efficiency of the overall computer system.

Fifth, the conversion of generated suggestions into user-presented output is frequently handled as a separate, late-stage concern, without integration into the upstream selection and timing logic. Prior systems may indiscriminately convert all generated suggestions into speech, consuming network bandwidth and processing resources, even when such suggestions are ill-timed or irrelevant. This lack of integrated filtering, ranking, and timing control increases computational overhead and degrades system responsiveness and scalability. Accordingly, there is a need for an improved computer-implemented system and method that: (i) tightly integrates audio capture, speech recognition, natural language processing, user profile management, similarity computation, prompt sentence generation, generative AI model invocation, safety filtering, and timing control within a unified processor-controlled architecture; (ii) employs structured vector representations and similarity measures to efficiently combine conversation context with user-specific data; (iii) constructs and manages prompt sentences for generative AI models in a systematic, resource-efficient manner; and (iv) determines and adjusts intervention timing based on a rich set of temporal and semantic features. Such improvements can enhance the technical functioning of the computer system itself in terms of latency, accuracy, stability, resource utilization, and scalability in real-time conversational support applications.

The specific processing by the specific processing unit 290 of the data processing device 12 in Example 1 is realized by the following means.

The present invention provides a server comprising a processor and a memory storing instructions that, when executed by the processor, cause the processor to acquire conversation audio via an input apparatus including an audio sensor, divide the conversation audio into time-based segments, and transmit or receive the time-based segments via a communication path; to perform speech recognition processing on the time-based segments to convert the conversation audio into character information; to perform natural language processing on the character information to generate utterance units and conversation intervals and to extract part-of-speech information, syntactic information, and semantic information; to classify, based on a result of the natural language processing, a conversation topic, a speaker intention, and an emotional state, and to generate, for each conversation interval, a topic information vector and an emotion information vector; to store, in a storage apparatus, a user information set including interest information, preference information, personality information, liking information, and behavior history information regarding a user, and to update and manage the user information set; to calculate a similarity between the topic information vector and an interest information vector obtained from the user information set, and to extract, based on the similarity, an effective interest target for the user; to generate, based on context information including character information of the conversation interval, the conversation topic, the speaker intention, the emotional state, and the effective interest target, a prompt sentence for input to a generative AI model; to operate the generative AI model by using the prompt sentence and generate a plurality of conversation candidate sentences that the user can utter in the conversation; to determine, for each of the conversation candidate sentences, content suitability and safety, and to select and rank the conversation candidate sentences based on the context information and the user information set; to analyze, based on utterance time information, silence interval information, speaker change information, and emotional variation information obtained from the conversation audio, a temporal flow of the conversation and determine an intervention time at which the selected conversation candidate sentences are to be presented by performing timing control; to, at the determined intervention time, input a selected conversation candidate sentence into a speech synthesis apparatus and generate synthesized speech corresponding to the conversation candidate sentence; and to present the synthesized speech, via an output apparatus worn by the user, as audio perceptible only to the user. This enables an integrated, processor-controlled improvement of the computer system's operation by optimizing how conversation context and user profile data are represented, combined, and processed; by systematically generating and constraining prompt sentences for the generative AI model; by dynamically selecting and timing contextually appropriate conversation suggestions; and by reducing unnecessary computation and communication, thereby improving latency, stability, and resource efficiency in real-time conversational assistance.

The term “conversation audio” refers to audio data representing spoken utterances exchanged between one or more human speakers in a shared environment, including pauses, overlaps, and background sounds captured by an audio sensor.

The term “input apparatus” refers to a hardware and software combination configured to capture physical audio signals from an environment and convert the signals into digital audio data for processing by a processor.

The term “audio sensor” refers to a transducer, such as a microphone, that converts acoustic pressure waves into electrical signals suitable for digitization.

The term “time-based segment” refers to a portion of audio data or character information that is delineated by a predefined time interval or duration and treated as a processing unit in a pipeline.

The term “communication path” refers to a logical or physical connection, including wired or wireless networks and associated protocols, that enables transmission and reception of data between a terminal and a server.

The term “speech recognition processing” refers to computational operations that convert audio data into character information using acoustic models, language models, or other pattern recognition techniques.

The term “character information” refers to a machine-readable textual representation of spoken content, including characters, words, symbols, and associated metadata such as timestamps or speaker identifiers.

The term “natural language processing” refers to a set of computational techniques for analyzing character information to identify linguistic structure, semantic content, and other language-related features.

The term “utterance unit” refers to a segment of character information corresponding to a single spoken turn or phrase, delineated by time, punctuation, or dialog structure.

The term “conversation interval” refers to a logically grouped portion of a conversation, consisting of one or more utterance units and associated temporal and contextual information.

The term “part-of-speech information” refers to data indicating grammatical categories of tokens in character information, such as nouns, verbs, adjectives, or adverbs.

The term “syntactic information” refers to data representing grammatical relationships and structural dependencies among tokens in character information.

The term “semantic information” refers to data indicating meanings, roles, or conceptual relationships associated with tokens, phrases, or sentences in character information.

The term “conversation topic” refers to a classification or label representing a primary subject matter or theme discussed within a conversation interval.

The term “speaker intention” refers to an inferred communicative goal or purpose of a speaker, such as asking a question, making a suggestion, or expressing an opinion.

The term “emotional state” refers to an inferred affective condition of a speaker, such as happiness, anxiety, boredom, or excitement, derived from audio or textual features.

The term “topic information vector” refers to a numerical representation, such as a vector in a multidimensional space, that encodes a conversation topic for computational comparison and analysis.

The term “emotion information vector” refers to a numerical representation that encodes an emotional state or distribution of emotional states for a conversation interval.

The term “storage apparatus” refers to a hardware and software arrangement, such as memory or persistent storage, configured to store and retrieve data under control of a processor.

The term “user information set” refers to a collection of data elements representing characteristics of a user, including but not limited to interest information, preference information, personality information, liking information, and behavior history information.

The term “interest information” refers to data describing subject areas, themes, or activities that a user is inclined to engage with or learn about.

The term “preference information” refers to data describing user-specific choices or tendencies regarding styles of interaction, conversation length, tone, or content types.

The term “personality information” refers to data describing relatively stable traits or behavioral tendencies of a user, such as introversion, extroversion, or openness.

The term “liking information” refers to data representing items, topics, or categories that a user favors or enjoys, derived from explicit input or inferred behavior.

The term “behavior history information” refers to data describing past actions or interactions of a user, including conversation logs, accepted suggestions, usage frequency, and temporal patterns.

The term “interest information vector” refers to a numerical representation derived from interest information that is suitable for similarity computation with other vectors.

The term “similarity” refers to a quantitative measure, such as cosine similarity or distance-based metric, indicating a degree of relatedness between two vectors or data representations.

The term “effective interest target” refers to one or more interest-related elements selected from a user information set that exhibit a similarity above a threshold with a conversation topic and are therefore deemed suitable for use in generating conversation suggestions.

The term “context information” refers to a collection of data describing the state of a conversation and a user at a given time, including character information, conversation topic, speaker intention, emotional state, and effective interest target.

The term “prompt sentence” refers to a structured textual input supplied to a generative AI model, including instructions, constraints, and contextual data that guide the model's output.

The term “generative AI model” refers to a machine learning model configured to generate new text sequences in response to input data, such as a large language model that produces conversation candidate sentences.

The term “conversation candidate sentence” refers to a machine-generated textual suggestion that can be uttered by a user as part of an ongoing conversation.

The term “content suitability” refers to an evaluation of whether a conversation candidate sentence is appropriate in view of the conversation topic, user characteristics, and system constraints.

The term “safety” refers to an evaluation of whether a conversation candidate sentence avoids harmful, offensive, or otherwise restricted content according to defined policies or rules.

The term “selection and ranking” refers to operations that choose a subset of conversation candidate sentences and order them according to predetermined criteria such as relevance, clarity, and safety.

The term “utterance time information” refers to data indicating start times, end times, and durations of spoken utterances in conversation audio.

The term “silence interval information” refers to data indicating durations and positions of non-speech periods within conversation audio.

The term “speaker change information” refers to data indicating boundaries or transitions between different speakers in a conversation.

The term “emotional variation information” refers to data representing changes in emotional state over time, derived from consecutive conversation intervals or utterances.

The term “temporal flow of the conversation” refers to a dynamic pattern of speech activity, pauses, speaker turns, and emotional changes over time in a conversation.

The term “timing control” refers to computational operations that determine when a system should present or withhold output based on temporal and contextual features of a conversation.

The term “intervention time” refers to a time point or time window at which the system is configured to present a selected conversation candidate sentence to a user.

The term “speech synthesis apparatus” refers to hardware and software components configured to convert character information into audio waveforms that represent spoken language.

The term “synthesized speech” refers to audio generated by a speech synthesis apparatus from character information, rather than recorded from a human speaker.

The term “output apparatus” refers to a device or combination of devices, such as earphones or wearable speakers, configured to deliver audio output to a user.

The term “audio perceptible only to the user” refers to audio output that is delivered in a manner such that it is intended to be heard exclusively or predominantly by a specific user, and not by surrounding persons.

In one embodiment, a server, a plurality of terminals, and a network together implement the system. The server includes at least one processor, a main memory, a non-volatile storage apparatus, and a network interface. The terminal includes a processor, a memory, an audio sensor such as a microphone, an output apparatus such as a wearable speaker or earphone, and a wireless communication module. The user operates or wears the terminal in a real-world conversational environment, such as a social event, a café, or a meeting.

The terminal captures conversation audio from the surrounding environment by using its audio sensor. The terminal applies an audio input library, such as a mobile operating system audio recording framework, to sample the analog speech signal, convert the signal to digital pulse-code-modulation data, and buffer the data in memory. The terminal executes a noise reduction algorithm, such as spectral subtraction or adaptive filtering, and optionally a beamforming algorithm using multiple microphones, to suppress ambient noise and improve the signal-to-noise ratio. The terminal thereby generates cleaned audio frames that are more suitable for downstream recognition on the server, which reduces recognition errors and re-processing overhead.

The server receives the audio frames via the network interface. The server stores the incoming frames in a time-ordered buffer in memory, and the server divides the conversation audio into time-based segments. The server represents each segment by a data structure that includes a segment identifier, a start time, an end time, a pointer to audio samples in storage, and metadata such as terminal identifier and language code. This explicit segmentation and structured representation enable efficient indexing and retrieval of segments, and prevent redundant copying of large audio buffers, thereby improving memory utilization and data access latency.

The server converts each time-based segment into character information by using a speech recognition engine executed on the processor. The server, in one embodiment, applies a neural-network-based automatic speech recognition model, such as a sequence-to-sequence model with an encoder-decoder architecture or a transformer-based architecture. The server computes acoustic features such as mel-frequency cepstral coefficients for each short-time frame of the audio, and the server feeds a sequence of feature vectors into the acoustic model. The acoustic model has multiple layers of neural units, including attention layers and feed-forward layers, and the server updates the internal representations layer by layer. The server then performs beam search decoding with a language model to determine the most probable text sequence for the segment. By executing such a model on dedicated hardware such as a graphics processing unit, the server reduces recognition latency and improves accuracy compared with traditional rule-based or single-layer models.

The server performs natural language processing on the character information. The server segments the character information into utterance units and conversation intervals, and the server assigns timestamps to each utterance based on the segment metadata. The server applies a natural language processing pipeline implemented by a software framework, which includes tokenization, part-of-speech tagging, syntactic parsing, and semantic role labeling. The server converts each utterance into a token sequence and applies an embedding model, such as a transformer-based encoder, to produce a high-dimensional vector for each utterance. The server then aggregates these vectors across a conversation interval to form a topic information vector and an emotion information vector. The server uses supervised classifiers, trained with labeled training data, to classify each interval into one or more conversation topics and one or more emotional states. The classifiers are implemented as neural networks that minimize a cross-entropy loss function on topic labels and emotion labels, and the server trains the networks by gradient-based optimization, updating the weight parameters with backpropagation. This design improves topic and emotion detection accuracy, which directly reduces downstream misclassification in timing control and suggestion selection.

The server stores and manages a user information set in the storage apparatus. The server organizes the user information set in a database that can be a relational database or a document-oriented database. The user information set includes interest information, preference information, personality information, liking information, and behavior history information. The server encodes each interest category and each preference attribute as an interest information vector in the same or a comparable vector space as the topic information vector. The server periodically updates these vectors based on observed user behavior, such as which suggestions are followed, which topics recur, and which conversations are prolonged. The server may use an online learning algorithm that adjusts vector weights when the user appears to adopt or ignore certain suggestions, thereby aligning the vector space with the user's evolving behavior. This adaptive representation makes the system more robust over time and avoids the static-profile limitation of conventional approaches.

The server calculates a similarity between the topic information vector and the interest information vector. The server uses a similarity metric such as cosine similarity, dot product similarity, or a learned similarity function implemented as a neural network that takes two vectors as input and outputs a relatedness score. The server selects an effective interest target by choosing one or more interest vectors whose similarity score exceeds a predefined or dynamically adjusted threshold. The server thereby reduces the candidate set of interests to a small subset that are both computationally manageable and contextually relevant. This similarity computation reduces unnecessary processing by the generative AI model and improves personalization quality.

The server generates a prompt sentence for a generative AI model based on the context information. The server constructs a structured representation that includes: the latest character information of the conversation interval, past character information within a predetermined time window, the conversation topic, the speaker intention, the emotional state, and the effective interest target. The server also includes expression style information that indicates the user's preferred speaking manner and tone, such as “short, polite questions” or “enthusiastic, friendly remarks.” The server converts this structured representation into a prompt sentence by applying a deterministic template or a rule set. For example, the server may generate a prompt sentence such as:

“The current conversation is about planning a summer trip to Italy. The speakers sound excited and are discussing which cities to visit. The user is interested in local food, culture, and photography, and prefers short, polite questions. Generate three short, natural sentences that the user could say next to contribute to the conversation. Each sentence should be easy for a shy person to say and should relate to both travel and local food or culture.”

The server may generate another prompt for timing evaluation, for example:

“You are evaluating a live conversation transcript. Here is the last 20 seconds of text: [transcript]. The conversation includes short pauses and some hesitation. Decide whether this is a natural moment for the assistant to whisper a suggestion to the user. Answer with ‘YES’ or ‘NO’ and then provide a one-sentence explanation.”

By generating such structured and constrained prompt sentences, the server controls the behavior of the generative AI model and reduces the likelihood of irrelevant or excessively long outputs, which lowers computational load and bandwidth usage.

The server operates the generative AI model by using the prompt sentence. The generative AI model, in one embodiment, is a large language model based on a transformer architecture with multiple self-attention layers and feed-forward layers. The server converts the prompt sentence into token identifiers and feeds them to the model, which produces contextual token representations and predicts subsequent tokens according to learned probability distributions. The model is trained on large-scale textual data using an auto-regressive objective, and the training process minimizes a log-likelihood loss function by adjusting the weight parameters via stochastic gradient descent or a variant thereof. During inference, the server controls output diversity and stability by setting parameters such as temperature, top-k, or top-p values. The server may run the generative AI model on a dedicated inference server that uses specialized hardware accelerators. This architecture enables the server to generate conversation candidate sentences with high fluency while maintaining throughput suitable for real-time applications.

The server determines content suitability and safety of each conversation candidate sentence.

The server applies a content filtering module, which may be a classifier trained to detect harmful categories of text or a rule engine that checks for prohibited terms. The server computes a safety score for each candidate and discards candidates that fall below a threshold. The server also computes a relevance score by comparing each candidate's content with the context information and the user information set. For example, the server may encode each candidate sentence as a vector and compute similarity with the topic information vector and the interest information vector. The server ranks the remaining candidates according to a composite score that reflects both safety and relevance. This multi-stage filtering and ranking reduces the number of candidate sentences that must be converted to audio, thereby reducing processing and transmission overhead.

The server analyzes the temporal flow of the conversation and determines an intervention time. The server derives utterance time information, silence interval information, speaker change information, and emotional variation information from the conversation audio and the character information. The server computes features such as silence duration, average utterance length, utterance frequency over time, and changes in emotion scores between successive intervals. The server feeds these features into a timing control algorithm. In one embodiment, the timing control algorithm is implemented as a state machine with states representing conversation conditions such as “active exchange,” “pause,” “topic change,” and “hesitation.” In another embodiment, the timing control algorithm is implemented as a trained classifier or regression model that outputs a probability that a given time window is suitable for an intervention. By exploiting multiple heterogeneous features, the server achieves more precise timing than simple threshold-based pause detection, which reduces user-perceived disruption and improves the overall technical performance of the interactive system.

The server generates synthesized speech from the selected conversation candidate sentence at the determined intervention time. The server uses a speech synthesis apparatus, which may be a neural text-to-speech engine with an encoder-decoder architecture, to convert the textual candidate into an audio waveform. The server selects a voice profile that matches the user's preferences stored in the user information set, such as a calm voice with a medium speaking rate. The server configures the speech synthesis parameters, including pitch, speed, and intonation pattern, to produce intelligible and natural-sounding output with minimal latency. By adjusting these parameters based on the user profile and conversation context, the server reduces the likelihood of misperception and listener fatigue.

The terminal receives the synthesized speech from the server via the communication path. The terminal buffers the received audio data and plays back the audio through the output apparatus, such as earphones or a wearable speaker, that is configured to deliver audio perceptible only to the user. The terminal may adjust playback volume and output channel based on user settings and ambient noise levels. The terminal thereby provides the user with a discrete auditory suggestion that does not disturb other people in the environment. This controlled delivery of suggestions is tightly integrated with the server-side timing and selection logic, and the coordination between server and terminal improves both user experience and resource usage.

The user listens to the synthesized speech and may choose to incorporate the suggested sentence into the ongoing conversation. The user's subsequent speech is again captured by the terminal audio sensor, and the cycle continues. Over time, the server logs outcomes, such as whether the user's utterance is closely aligned with the suggested sentence or diverges from it. The server can use this behavioral evidence to update the user information set, adjust interest information vectors, and refine the similarity thresholds. The server may periodically retrain its topic classification, emotion classification, and timing control models using stored conversation intervals and user feedback, thereby improving technical performance metrics, such as prediction accuracy, latency, and bandwidth consumption.

In alternative embodiments, the server and terminal configuration may vary. The server may be implemented as a distributed cluster of processors, each responsible for a subset of functions, such as speech recognition, natural language processing, generative model inference, and speech synthesis. The terminal may be a smartphone, a tablet, a smartwatch, earphone hardware, or another wearable device with audio capture and playback capabilities. The system may employ different algorithms for feature extraction, such as filter-bank-based features, or different neural architectures, such as recurrent networks or convolutional networks, depending on performance constraints. In some embodiments, parts of the speech recognition or natural language processing pipeline may be offloaded to the terminal when local processing power is sufficient, reducing network latency and server load.

The described configuration of the server, terminal, and data processing pipeline yields technical effects beyond simple automation of human tasks. By systematically structuring conversation audio into time-based segments, representing conversation topics and user interests as vectors, computing similarities, and generating constrained prompt sentences for a generative AI model, the server reduces redundant processing, improves cache locality, and enhances throughput for real-time multi-user scenarios. By integrating multi-feature timing control and safety-aware selection before invoking speech synthesis and transmission, the system reduces network traffic and processing cycles devoted to unused or inappropriate suggestions. These improvements in data management, algorithmic control, and hardware utilization constitute a concrete enhancement of computer technology and enable the system to deliver context-aware, user-specific conversational assistance with higher speed, greater accuracy, and improved resource efficiency.

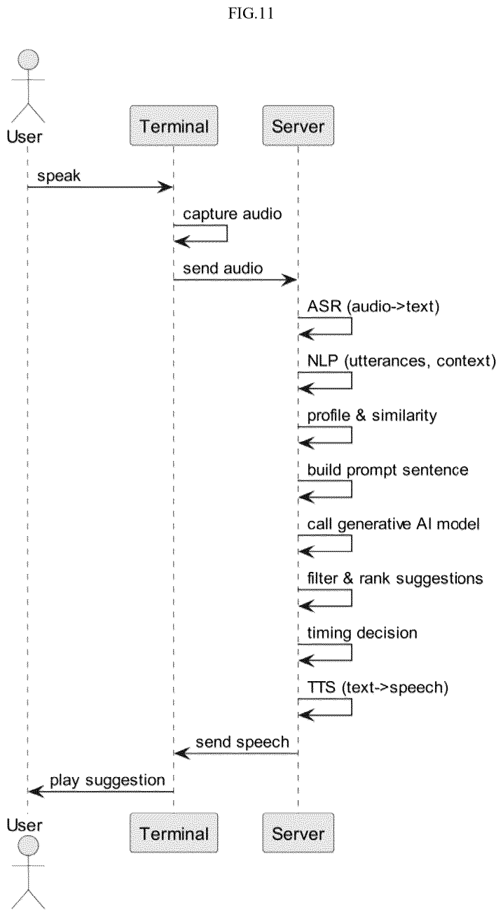

The following describes the processing flow using FIG. 11.

### Step 1:

The terminal captures conversation audio from the surrounding environment. The input to this step is an analog sound wave produced by one or more speakers near the terminal. The terminal uses its audio sensor and an audio recording framework to sample the analog sound at a fixed sampling rate and convert it into digital audio frames represented as pulse-code-modulation values. The terminal stores these frames in a ring buffer in memory and applies a noise reduction algorithm and, if available, a beamforming algorithm to suppress background noise. The output of this step is a sequence of cleaned digital audio frames, each tagged with a timestamp and stored in the terminal memory.

### Step 2:

The terminal prepares and transmits time-based audio segments to the server. The input to this step is the sequence of cleaned digital audio frames produced in Step 1. The terminal groups the frames into contiguous segments of a fixed duration, such as several seconds, and encapsulates each segment in a data structure that includes segment identifiers, start and end times, and audio format information. The terminal then establishes a secure network connection to the server and sends each segment through a communication protocol. The output of this step is a stream of time-based audio segment packets transmitted to the server.

### Step 3:

The server receives and buffers the time-based audio segments. The input to this step is the stream of audio segment packets arriving from one or more terminals. The server validates each packet, extracts the audio data and associated metadata, and stores the audio data in a time-ordered buffer in memory or in temporary storage. The server assigns a unique internal identifier to each segment and records the mapping between the segment identifier, terminal identifier, and timestamps. The output of this step is a set of stored audio segment records ready for speech recognition processing.

### Step 4:

The server performs speech recognition on each audio segment. The input to this step is a stored audio segment record that contains digital audio samples and metadata. The server computes acoustic features, such as mel-frequency cepstral coefficients, from the raw audio samples and feeds the resulting feature vectors into a trained speech recognition model. The server applies the model's encoder layers to generate internal representations and uses a decoding procedure, such as beam search with a language model, to produce the most likely sequence of text tokens. The server converts these tokens into character information, including words and punctuation, and associates timestamps with the recognized text. The output of this step is a transcript object that contains character information for the segment and alignment information between audio frames and text tokens.

### Step 5:

The server segments the transcript into utterance units and conversation intervals. The input to this step is the transcript object produced in Step 4. The server analyzes the timestamps, pauses between words, and speaker identifiers, if available, to determine boundaries between utterances. The server groups related utterances into conversation intervals based on proximity in time and continuity of topic. The server creates data structures for each utterance unit and each conversation interval, and stores them in a conversation buffer associated with the corresponding user. The output of this step is a set of utterance unit records and conversation interval records, each linked to the original audio segments and the user.

### Step 6:

The server extracts linguistic and semantic information from the conversation intervals. The input to this step is the set of conversation interval records from Step 5. The server uses a natural language processing pipeline to tokenize the character information, assign part-of-speech tags, and perform syntactic parsing for each utterance. The server then applies semantic analysis, including semantic role labeling and named entity recognition, to identify roles and entities in the conversation. The server aggregates these results within each conversation interval and stores part-of-speech information, syntactic information, and semantic information as structured attributes attached to the corresponding interval records. The output of this step is an enriched set of conversation interval records containing detailed linguistic annotations.

### Step 7:

The server computes topic and emotion vectors for each conversation interval. The input to this step is the enriched conversation interval records with linguistic annotations from Step 6. The server applies an embedding model to convert each utterance or sentence into a numerical vector, then aggregates these vectors within an interval by averaging or applying an attention-based pooling mechanism. The server feeds the aggregated vector into trained classifiers for topic detection and emotion classification, obtaining probability distributions over predefined topic classes and emotion classes. The server converts these distributions into a topic information vector and an emotion information vector for each interval. The output of this step is a set of interval records augmented with topic information vectors and emotion information vectors.

### Step 8:

The server retrieves and updates the user information set. The input to this step is a user identifier associated with the conversation intervals from Step 7. The server queries a user database to load the user information set, which includes interest information, preference information, personality information, liking information, and behavior history information. The server may update behavior history by appending the current conversation interval identifiers and detected topics or by adjusting counters indicating how frequently each topic appears in conversations for this user. The server writes these updates back to the database. The output of this step is a current user information set in memory, prepared for similarity computation.

### Step 9:

The server computes similarity between conversation topics and user interests. The input to this step is the topic information vector for the current conversation interval and a collection of interest information vectors derived from the user information set. The server calculates similarity scores between the topic information vector and each interest information vector by using a numerical similarity measure, such as cosine similarity. The server selects interest vectors whose similarity scores satisfy a threshold or are within a top-ranked subset. The server designates these selected interests as effective interest targets and stores them as part of the context for the current interval. The output of this step is a list of effective interest targets associated with the conversation interval.

### Step 10:

The server constructs structured context information for prompt generation. The input to this step is the current conversation interval record, the user information set, the topic information vector, the emotion information vector, and the effective interest targets from Step 9. The server collects elements such as the latest character information, a summary of previous utterances within a predetermined time window, the identified topic and emotion labels, the effective interest targets, and expression style information derived from user preferences. The server arranges these elements into a structured context object that defines what information should be conveyed to the generative AI model. The output of this step is a structured context object representing the state of the conversation and user preferences.

### Step 11:

The server generates a prompt sentence for the generative AI model. The input to this step is the structured context object from Step 10. The server applies a template or a set of prompt construction rules to convert the structured context into natural language instructions and descriptions. The server may, for example, combine the topic description, emotion description, user interests, and style constraints into a coherent text. The server produces a prompt sentence such as: “The current conversation is about planning a summer trip to Italy. The speakers sound excited and are discussing which cities to visit. The user is interested in local food, culture, and photography, and prefers short, polite questions. Generate three short, natural sentences that the user could say next to contribute to the conversation.” The output of this step is a prompt sentence ready to be input to the generative AI model.

### Step 12:

The server invokes the generative AI model using the prompt sentence. The input to this step is the prompt sentence generated in Step 11. The server tokenizes the prompt sentence, maps each token to an identifier, and feeds the sequence of identifiers into the generative AI model. The model computes contextual representations through multiple attention and feed-forward layers, then predicts successive output tokens according to learned probability distributions. The server controls the generation process by setting parameters such as maximum length and sampling temperature. The server decodes the output tokens into human-readable text and segments the generated text into individual conversation candidate sentences. The output of this step is a list of conversation candidate sentences produced by the generative AI model.

### Step 13:

The server evaluates content suitability and safety for each conversation candidate sentence. The input to this step is the list of conversation candidate sentences from Step 12, together with the context information and user information set. The server passes each candidate sentence through a safety filter, which may include a classifier or rule-based checks to detect prohibited or sensitive content. The server computes a safety score and discards or flags sentences that do not meet safety requirements. The server also computes a relevance score by encoding each candidate into a vector and measuring similarity with the topic information vector and the effective interest targets. The server combines safety and relevance scores into a composite score for each candidate. The output of this step is a filtered and scored list of conversation candidate sentences.

### Step 14:

The server selects and ranks conversation candidate sentences. The input to this step is the filtered and scored list from Step 13. The server sorts the candidate sentences in descending order of their composite scores and selects one or more top-ranked sentences for potential presentation to the user. The server may apply additional constraints, such as maximum number of sentences or diversity criteria, to avoid redundancy. The output of this step is a final set of selected conversation candidate sentences, each with an associated rank and score.

### Step 15:

The server analyzes the temporal flow of the conversation to determine an intervention time. The input to this step is the conversation interval records, including utterance time information, silence interval information, speaker change information, and emotional variation information, along with the current time and the selected candidate sentences from Step 14. The server computes features such as the duration of the latest silence, the average length of recent utterances, the rate of speaker turns, and changes in emotion scores between consecutive intervals. The server applies a timing control algorithm or model to classify the current conversation state and calculate a probability that this moment is suitable for presenting a suggestion. If the probability or decision meets a configured threshold, the server designates the current or upcoming time window as the intervention time. The output of this step is a decision indicating whether and when to deliver a selected conversation candidate sentence.

### Step 16:

The server generates synthesized speech for the selected conversation candidate sentence. The input to this step is a selected conversation candidate sentence from Step 14 and the intervention time decision from Step 15. The server sends the sentence text and user-specific voice parameters to a speech synthesis apparatus. The speech synthesis apparatus converts the text to phoneme or acoustic feature sequences and then generates a waveform using a vocoder model. The server may adjust parameters such as speaking rate and pitch to match the user's preferences and the emotional tone of the conversation. The output of this step is an audio file or audio stream that contains synthesized speech corresponding to the selected candidate sentence.

### Step 17:

The server transmits the synthesized speech to the terminal. The input to this step is the synthesized speech data from Step 16 and the targeting information for the corresponding terminal and user. The server packages the audio data into a transport format and sends it through the communication path to the terminal, optionally using streaming to reduce perceived latency. The server may include metadata such as message identifiers and playback instructions. The output of this step is a stream of synthesized speech data received by the terminal.

### Step 18:

The terminal plays back the synthesized speech for the user. The input to this step is the synthesized speech data received from the server in Step 17. The terminal buffers the audio data and uses an audio playback framework to decode and send the audio samples to the output apparatus, such as an earphone or wearable speaker. The terminal sets the output volume and channel configuration to ensure that the audio is perceptible primarily to the user. The terminal may also provide a vibration or visual indicator to signal that a suggestion is being delivered. The output of this step is a real-time audio presentation of the suggestion to the user.

### Step 19:

The user listens to the suggestion and responds in the ongoing conversation. The input to this step is the audio suggestion presented by the terminal in Step 18 and the surrounding real-world conversation. The user cognitively interprets the suggestion, optionally adapts or paraphrases it, and then speaks aloud to contribute to the conversation. The user's spoken response becomes new conversation audio in the environment. The output of this step is a new segment of conversation audio that includes the user's response and is subsequently captured by the terminal, causing the processing flow to repeat from Step 1.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented dialogue support systems that use speech recognition and natural language processing suffer from several technical limitations in accurately and efficiently supporting real-time, personalized conversations, particularly in environments where multiple speakers and background noises are present. First, typical systems treat the output of a language model as a direct response generator without explicitly modeling, at the system level, how raw audio signals are transformed into structured conversational context and then into a prompt sentence suitable for a generative AI model. As a result, such systems often generate responses that are semantically misaligned with the current conversation state or the user's long-term profile, thereby reducing the effectiveness of the system and increasing the need for manual intervention or rule tuning.

Second, existing architectures generally do not incorporate a dedicated, algorithmically defined timing control mechanism that operates on low-level acoustic features (such as silence duration, utterance boundaries, and voice intensity) and high-level semantic features (such as detected emotion and topic) in an integrated manner. Instead, they rely on simple heuristics (for example, fixed delays or manual triggers) to decide when to present generated content. This leads to technically suboptimal utilization of computing resources and causes the system to either interrupt the user's speech or miss opportunities to intervene, resulting in degraded user experience and inefficient processing.

Third, conventional systems lack a structured, programmatic pipeline that transforms real-time audio streams into context-enriched prompt sentences for a generative AI model while dynamically adapting to changes in user state and preferences. Without such a pipeline, the generative AI model may be invoked with incomplete or noisy context, leading to low-quality outputs. This not only degrades personalization performance but also increases repeated inference calls and unnecessary processing, which negatively impacts latency, memory usage, and network bandwidth.

Accordingly, there is a need for an improved computer-implemented system that (i) acquires and processes audio information in real time, (ii) converts the audio information into structured language and profile information, (iii) automatically generates optimized prompt sentences for a generative AI model based on both conversation context and user profile, and (iv) algorithmically determines an appropriate presentation timing for generated conversation candidate information. Such a system should improve the technical functioning of the dialogue support platform itself by reducing misalignment between generated content and user state, by controlling generative AI inference in a resource-efficient manner, and by coordinating audio input, language analysis, and audio output at the processor level to provide more stable, predictable, and technically robust operation.

The specific processing by the specific processing unit 290 of the data processing device 12 in Application Example 1 is realized by the following means.

The present invention provides a server comprising a processor configured to acquire audio information representing ambient sound, convert the audio information into language information, analyze the language information to extract topic information, emotion information, and intent information, manage user attribute information, preference information, and conversation history information in a profile database, automatically generate a prompt sentence by integrating a latest analysis result of conversation content and user profile information, input the prompt sentence with at least one constraint relating to a writing style, a length, and a prohibited content of an output sentence to a generative AI model, obtain conversation candidate information from the generative AI model, determine a presentation timing for the conversation candidate information based on time information, silence information, voice intensity information, utterance boundary information, and the emotion information, and convert the conversation candidate information into an audio signal and output the audio signal in accordance with the determined presentation timing. This enables coordinated and adaptive control of end-to-end conversational processing at the server side, including structured prompt generation for the generative AI model and algorithmic timing determination for presenting generated content, thereby improving system-level performance in terms of response relevance, latency, and robustness in noisy, real-time conversational environments.

The term “audio information” refers to data representing sound, including but not limited to digitized signals obtained from one or more sound pickup devices that capture ambient sound such as human speech.

The term “audio information acquisition unit” refers to a functional component implemented by hardware, software, or a combination thereof, which captures ambient sound in real time and outputs corresponding audio information to another component of the system.

The term “audio information conversion unit” refers to a functional component implemented by hardware, software, or a combination thereof, which converts audio information into language information by performing speech recognition or similar processing.

The term “language information” refers to data representing linguistic content derived from audio information, including but not limited to character strings, words, phrases, and sentences obtained by speech recognition.

The term “language information analysis unit” refers to a functional component implemented by hardware, software, or a combination thereof, which analyzes language information to extract higher-level features such as topic information, emotion information, and intent information.

The term “topic information” refers to data indicating a subject or theme of a conversation, inferred from language information, such as health, hobbies, daily activities, or other semantic categories.

The term “emotion information” refers to data representing an estimated emotional state associated with language information, including but not limited to qualitative labels, quantitative scores, or categories such as positive, negative, neutral, calm, or excited.

The term “intent information” refers to data indicating a communicative purpose or goal inferred from language information, such as requesting information, expressing a condition, making a statement, or recalling a memory.

The term “attribute information” refers to data representing characteristics of a user, including but not limited to demographic attributes, preference attributes, and behavioral attributes.

The term “preference information” refers to data representing likes, dislikes, interests, and tendencies of a user, such as preferred topics, favored activities, and frequently selected conversation contents.

The term “conversation history information” refers to data representing past conversation content and related metadata, including previously generated utterances, recognized user utterances, timestamps, and associated analysis results.

The term “profile database” refers to a data storage structure implemented on a storage device, which stores user attribute information, preference information, and conversation history information in association with user identifiers.

The term “attribute information management unit” refers to a functional component implemented by hardware, software, or a combination thereof, which stores, retrieves, and updates user attribute information, preference information, and conversation history information in the profile database.

The term “user profile information” refers to a collection of data items associated with an individual user, including at least attribute information, preference information, and conversation history information, used for personalization of system behavior.

The term “prompt sentence” refers to text data to be input to a generative AI model, the text data including at least contextual information such as analysis results of conversation content and user profile information, and optionally including constraints relating to a writing style, a length, or prohibited content of an output sentence.

The term “generative AI model” refers to a machine learning model, such as a neural network language model, that generates text or other data in response to an input including a prompt sentence.

The term “conversation candidate information” refers to text data output from a generative AI model in response to a prompt sentence, the text data being suitable to be used as a candidate utterance or topic in a conversation with a user.

The term “conversation candidate information generation unit” refers to a functional component implemented by hardware, software, or a combination thereof, which generates a prompt sentence based on analysis results and user profile information, inputs the prompt sentence to a generative AI model, and obtains conversation candidate information from the generative AI model.

The term “time information” refers to data indicating temporal aspects of audio information or language information, including but not limited to timestamps, durations of utterances, and intervals of silence.

The term “silence information” refers to data indicating the presence, duration, or pattern of non-speech segments within audio information.

The term “voice intensity information” refers to data representing a magnitude or level of acoustic energy of audio information, used to distinguish between active speech and low-level background sound.

The term “utterance boundary information” refers to data indicating segment boundaries between individual utterances within continuous audio information or language information.

The term “presentation timing” refers to a time point or a temporal order determined for outputting conversation candidate information to a user.

The term “presentation timing determination unit” refers to a functional component implemented by hardware, software, or a combination thereof, which calculates a presentation timing for conversation candidate information based on at least time information, silence information, voice intensity information, utterance boundary information, and optionally emotion information.

The term “control logic” refers to a set of rules, algorithms, or program instructions implemented by hardware, software, or a combination thereof, which determines how input parameters are processed to produce control outputs such as presentation timing.

The term “audio output unit” refers to a functional component implemented by hardware, software, or a combination thereof, which converts conversation candidate information into an audio signal and outputs the audio signal through at least one sound reproduction device.

The term “server” refers to a computing apparatus including at least one processor and at least one memory, which executes one or more units or functions described in the system, including acquisition, conversion, analysis, management, generation, determination, and output processing.

The term “processor” refers to a hardware processing element, such as a central processing unit, a graphics processing unit, a digital signal processor, or any combination thereof, capable of executing instructions to realize functions of the units described herein.

In one embodiment, a server, one or more terminals, and one or more users cooperate to implement the claimed system. The server includes at least one processor, a main memory, a non-volatile storage device, and a network interface. The terminal includes at least one processor, a memory, a microphone, a loudspeaker, and a wireless or wired communication interface. The user is a human person who utters speech and listens to audio output.

The server executes an operating system, such as a general-purpose server operating system, and application programs implementing an audio information acquisition unit, an audio information conversion unit, a language information analysis unit, an attribute information management unit, a conversation candidate information generation unit, a presentation timing determination unit, and an audio output control unit. The terminal executes an operating system for a portable information device and an application implementing local audio capture, buffering, and playback.

The terminal uses one or more microphones, such as a directional array microphone or a high-sensitivity condenser microphone, to capture ambient sound in a physical environment. The terminal converts incoming analog signals into digital audio information by using an audio codec at, for example, 16 kHz sampling frequency and 16-bit quantization. The terminal may apply front-end signal processing, such as beamforming and noise reduction, using a digital signal processing library. The terminal then transmits the audio information to the server through the network interface using a communication protocol such as HTTP or a persistent bidirectional protocol.

The server receives the audio information as time-stamped audio frames and stores them in memory using a ring buffer structure. Each audio frame includes at least a device identifier, a room identifier, and a timestamp. The server uses the audio information conversion unit to convert the audio information into language information. In one embodiment, the server runs an automatic speech recognition engine implemented by a neural network, such as a convolutional-recurrent network or a transformer-based acoustic model trained on speech of elderly speakers. The server extracts acoustic features, such as Mel-frequency cepstral coefficients and log-Mel spectrograms, and feeds the features into the neural network. The neural network outputs probability distributions over phoneme or subword units, and the server applies a decoding algorithm, such as a beam search with an n-gram or neural language model, to generate text sequences. The server thus produces language information in the form of character strings and word sequences with timestamps and confidence scores.

The server stores the generated language information in a structured conversation log. The conversation log associates each utterance with a user identifier, a timestamp, an estimated speaker label if available, and a pointer to the corresponding raw audio segment. The server then uses the language information analysis unit to analyze the language information. In one embodiment, the server applies a natural language processing pipeline comprising tokenization, sentence segmentation, part-of-speech tagging, dependency parsing, and named entity recognition, implemented using a language processing library or a transformer-based model. The server uses a trained classifier, for example a transformer network fine-tuned for topic and emotion classification, to compute topic information as categorical labels (such as “health,” “hobby,” “family”) and emotion information as continuous scores or discrete labels (such as “tired,” “cheerful,” “neutral”). The server further uses an intent classifier, which may be implemented as a multi-layer feed-forward network on top of sentence embeddings, to infer intent information such as “state physical condition,” “recall memory,” or “ask factual question.”

The attribute information management unit in the server maintains a profile database on a storage device. The profile database may be implemented using a relational database or a document-oriented database. For each user, the server stores attribute information such as age range, language, and cognitive level, preference information such as preferred topics, favorite activities, and preferred speaking style, and conversation history information such as past topics, durations of responses, and observed emotion trends. The server updates these records based on outputs of the language information analysis unit. For example, when the server detects positive emotion and long response duration for a particular topic, the server increments a preference score in the database for that topic. The server updates preference vectors by using an online learning algorithm, such as stochastic gradient updates on a user-topic embedding space, to adapt over time.

The conversation candidate information generation unit in the server generates a prompt sentence for a generative AI model. The server retrieves, from the profile database, user profile information corresponding to a current user identifier and combines it with the language information analysis results of recent utterances. The server constructs a prompt sentence in natural language that explicitly includes the latest conversation content, summarized topic and emotion, and key profile attributes. In addition, the server appends constraints describing writing style, output length, and prohibited content. For example, the server may generate the following prompt sentence:

“The elderly resident says: ‘I feel a little tired today.’

The profile shows that the resident enjoys gardening and traveling and used to be a primary school teacher. The current mood is slightly tired but calm.

As a conversation assistant, generate one short, gentle question (1-2 sentences) in polite Japanese that invites the resident to recall a pleasant memory related to gardening or travel. Avoid giving any medical advice or using complex vocabulary.”

In another example, the server may generate a Japanese prompt sentence such as:

“An elderly user has uttered, ‘I feel a little tired today.’

The profile indicates the following: hobbies include gardening and traveling, and the former occupation was a primary school teacher. The current mood is estimated to be ‘slightly tired but calm.’

As a conversation-support AI in an elderly care facility, generate one gentle and encouraging question consisting of one to two sentences that helps ease the user's mood. The content should naturally lead to a pleasant memory related to gardening or travel. Do not perform any medical treatment or diagnosis.”

The server inputs the prompt sentence to a generative AI model. In one embodiment, the generative AI model is a large-scale neural network language model of the transformer architecture with multiple self-attention layers and feed-forward layers, pre-trained on text data and fine-tuned for conversational style. The model parameters are stored in memory and executed on one or more processing units, such as graphics processing units. The server performs inference by tokenizing the prompt sentence, converting tokens into embeddings, and iteratively computing attention and feed-forward operations to produce output token probabilities. The server uses a decoding algorithm, such as nucleus sampling or beam search with constraints on maximum length, to generate conversation candidate information as a sequence of text tokens. The server filters the generated text by checking for forbidden terms or patterns and truncates text exceeding length limits.

The presentation timing determination unit in the server uses both low-level acoustic data and high-level semantic data to decide when the system should present the conversation candidate information. The server tracks, in memory, a time series of speech segments, silence segments, and audio energy values derived from the audio information. The server computes silence durations between utterances by subtracting timestamps and detects utterance boundaries using energy thresholds and pause patterns. The server also reads emotion information from the language information analysis unit and accumulates a metric representing user engagement, for example, based on response length and emotional valence. The server calculates a presentation score for each potential time point. In one embodiment, the server applies a control logic that includes a rule-based component and a learned component. The rule-based component may enforce that the presentation timing occurs only after a minimum silence duration and not during a user utterance. The learned component may be implemented by a small neural network or logistic regression model that receives as input features such as current silence duration, recent topic transitions, and emotion trend. The server compares the presentation score with a threshold that may be adapted over time based on user behavior. If the score exceeds the threshold, the server schedules the conversation candidate information for output.

The audio output unit in the server converts the conversation candidate information into an audio signal. The server invokes a text-to-speech engine, which may be implemented by a parametric synthesis engine, a concatenative engine, or a neural network-based engine that maps character or phoneme sequences to audio waveforms. The server specifies synthesis parameters, such as speech rate, pitch, and volume, to match user preferences stored in the profile database. The server then transmits the synthesized audio signal to the terminal, together with control data indicating when and how the audio is to be played.

The terminal receives the audio signal and control data and stores them in a playback buffer. The terminal reads the control data and starts playback at the designated time through its loudspeaker. The user hears the generated utterance, such as:

“When you've been feeling a little tired lately, is there a travel destination where you remember spending time in a relaxed and leisurely way?”

The user responds by speaking, the terminal captures the new audio, and the server continues the described processing.

In one embodiment, the server uses a specific data structure for managing the entire conversation cycle. The server may maintain, in memory, a context object containing a sliding window of recent utterances, each represented by a tuple including text, topic, emotion, intent, and timestamp. The server generates the prompt sentence by serializing selected fields from this context object and the user profile record. Because the prompt sentence is automatically constructed using reproducible rules and structured data, the server can systematically vary and optimize the information presented to the generative AI model. This structured flow reduces unnecessary token length in prompts, thereby reducing computation time and improving inference latency.

The described architecture improves computer technology in several ways. First, the integration of multi-level features (time information, silence information, voice intensity information, utterance boundary information, and emotion information) into the presentation timing determination unit allows the processor to schedule generative AI inference and audio output in a technically optimized manner. By avoiding generation during periods of high user speech activity and by focusing inference around detected boundaries, the server reduces redundant inference calls, lowers network traffic between server and terminals, and improves effective throughput of the processing hardware.

Second, the automatic construction of prompt sentences from structured conversation context and user profile information improves the accuracy and efficiency of the generative AI model. Because the server excludes irrelevant historical content and compresses context into a concise, semantically rich representation, the generative AI model can produce more relevant conversation candidate information with fewer tokens. This reduces the average number of computational steps per inference and shortens response times. The server can further adapt prompt construction rules over time based on measurable outcomes, such as user engagement metrics, creating a feedback-controlled computational pipeline rather than a static scripted interaction.

Third, the server implements training and adaptation procedures that are not a mere automation of human work. For example, the server can use logs of conversation candidate information and user reactions to perform off-line fine-tuning of the topic and emotion classifiers and to adjust weights in the prompt construction module. The server may define loss functions that measure mismatches between predicted user engagement and observed engagement, and update parameters in neural networks using gradient descent. The server may use data augmentation, such as random masking of words or paraphrasing in training data, to improve robustness of the language information analysis unit and reduce error rates on noisy speech input. These procedures improve the internal operation of the computational models, such as reducing classification error and improving stability in the presence of acoustic noise, thereby enhancing the technical performance of the system.

In another embodiment, the server uses a rule-based generative component instead of, or in combination with, a neural generative AI model. The server may maintain rule templates that fill in slots with entities extracted from language information. For instance, if the topic is “gardening” and a plant name is detected, the server generates a candidate question, such as “How long have you been growing [plant name]?” In such a hybrid embodiment, the conversation candidate information generation unit chooses between rule-based and neural-generated content based on conditions such as confidence levels, device load, or regulatory constraints. This hybrid strategy allows the server to reduce dependency on large neural network inference for simple cases, further improving computational efficiency.

In yet another embodiment, the terminal executes a portion of the processing locally to reduce communication load and latency. The terminal may run a lightweight speech recognition model for wake-word detection and basic command recognition, and send only selected segments to the server for full analysis and generative processing. The terminal may also cache frequent audio output messages locally. By distributing processing in this manner, the system reduces round-trip time and lowers bandwidth requirements, which constitutes a technical improvement in communication efficiency.

The described embodiments focus on internal computer operations, such as transforming unstructured audio waveforms into structured language information, analyzing features with trained models, constructing constrained prompt sentences, performing controlled generative inference, and determining precise output timing based on multi-modal features. These operations are not limited to automating a human conversational task but provide a non-trivial improvement in how a computer system manages conversational data, schedules computation, and allocates processing resources. The causality between these operations and the technical effects is as follows: structured context and profile integration into prompt sentences reduces unnecessary processing and improves response relevance; dynamic timing control based on quantitative acoustic and semantic features reduces interference with user speech and lowers error rates in turn-taking; and adaptive profile and classifier updates improve long-term performance, reduce misclassification of user state, and maintain stable system operation in complex, noisy environments.

Alternative embodiments may employ different neural network architectures, such as recurrent neural networks or convolutional neural networks, for speech recognition or language understanding, or different database technologies for the profile database. However, in each embodiment, the server, the terminal, and the user cooperate such that the processor in the server executes a defined sequence of data transformations on specific data structures, leading to improved technical performance in real-time conversational assistance using a generative AI model and prompt sentences.

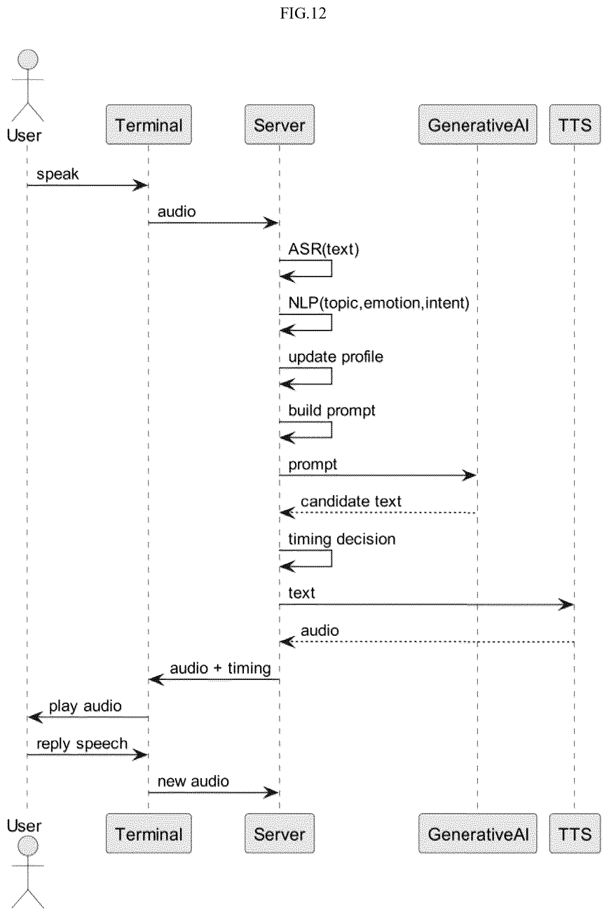

The following describes the processing flow using FIG. 12.

### Step 1:

The terminal captures ambient sound and generates audio information.

The terminal uses one or more microphones to receive analog sound waves produced by the user and other speakers in the environment. As input, the terminal receives continuous analog signals from the microphones. The terminal samples the analog signals at a predetermined sampling rate (for example, 16 kHz, 16-bit) and converts them into digital audio frames. The terminal applies basic signal processing, such as noise reduction and, if available, beamforming, to suppress background noise. As output, the terminal generates time-stamped digital audio frames including at least device identifier, room identifier, and raw waveform samples.

### Step 2:

The terminal transmits the audio information to the server.

The terminal uses a communication interface to send the digital audio frames to the server. As input, the terminal uses the buffered audio frames generated in Step 1. The terminal encapsulates the frames with metadata (timestamps, device identifiers, approximate user identifiers if available) into network packets and transmits them via a protocol such as HTTP or a persistent streaming protocol. As output, the terminal delivers a sequence of audio packets to the server's network interface for further processing.

### Step 3:

The server receives the audio information and stores it in a buffer.

The server uses the network interface to accept incoming audio packets from the terminal. As input, the server receives the audio packets containing digital audio frames and associated metadata. The server reconstructs the frame sequence, verifies integrity (for example, by checking sequence numbers), and stores the frames in a ring buffer in main memory. The server tags each frame with unified timestamps and stores pointers for quick access. As output, the server provides buffered audio information organized by user or device stream for subsequent speech recognition.

### Step 4:

The server converts the audio information into language information.

The server uses an audio information conversion unit (speech recognition engine) to perform automatic speech recognition. As input, the server takes the buffered audio frames for a given time interval. The server computes acoustic features, such as Mel-frequency cepstral coefficients or log-Mel spectrograms, by applying windowing, Fourier transforms, and filter banks to the waveform samples. The server feeds the feature sequences into a trained neural network acoustic model (for example, a transformer-based or recurrent model). The neural network outputs probability distributions over phoneme or subword units at each time step. The server applies a decoding algorithm, such as beam search with a language model, to determine the most probable sequence of tokens and converts the tokens into words or characters. As output, the server generates language information in the form of recognized text with timestamps and confidence scores.

### Step 5:

The server logs the language information in a structured conversation record.

The server stores the recognized text and associated metadata in a conversation log structure.

As input, the server uses the language information from Step 4, including text, timestamps, and confidence scores, and the audio metadata from Step 3. The server creates or updates conversation records, each record including fields such as user identifier, utterance identifier, start time, end time, recognized text, and links to the original audio frames. The server may group consecutive utterances into sessions. As output, the server produces a persistent conversation log in a database or in-memory data structure for later analysis.

### Step 6:

The server analyzes the language information to extract topic, emotion, and intent.

The server uses a language information analysis unit to perform natural language processing. As input, the server takes the recognized text from the conversation log, along with timestamps and user identifiers. The server tokenizes the text, identifies sentence boundaries, and applies part-of-speech tagging and dependency parsing. The server then generates sentence embeddings using a neural model (for example, a transformer encoder) and feeds these embeddings into classifiers for topic, emotion, and intent. The topic classifier outputs labels like “health,” “hobby,” or “family.” The emotion classifier outputs labels or scores such as “tired,” “neutral,” or “cheerful.” The intent classifier outputs labels such as “report condition” or “recall memory.” As output, the server produces structured analysis results that associate each utterance with topic information, emotion information, and intent information.

### Step 7:

The server updates and retrieves user profile information.

The server uses an attribute information management unit to maintain user profiles in a profile database. As input, the server uses the user identifier from the conversation log and the analysis results from Step 6. The server retrieves the existing user profile record, which may include attributes such as age range, language preference, interests (for example, gardening, travel), and historical engagement metrics. The server updates preference scores based on observed behavior; for example, the server increases a topic preference score when the user shows positive emotion and longer responses for a given topic. The server may also update fields such as “recent mood trend.” As output, the server provides an updated user profile and a current snapshot of user profile information for use in prompt construction.

### Step 8:

The server constructs a context object for prompt generation.

The server creates a structured context object that aggregates recent conversation and profile data. As input, the server uses the latest N utterances from the conversation log, together with their topics, emotions, and intents from Step 6, and the updated user profile from Step 7. The server selects key fields, such as the user's latest statement, the current dominant topic, the current estimated emotion, and stable profile attributes (for example, hobbies and past occupation). The server organizes this data into a machine-readable context object with explicit fields and identifiers. As output, the server provides this context object as a compact representation of the user's current state and history for the next processing step.

### Step 9:

The server generates a prompt sentence for a generative AI model.

The server uses the conversation candidate information generation unit to convert the context object into a natural language prompt sentence. As input, the server takes the context object from Step 8. The server serializes key fields into text, for example: the user's latest utterance, a description of the user's hobbies, and the current mood. The server appends explicit constraints about writing style, output length, and prohibited content. The server may also include role instructions specifying that the generative AI model should act as a gentle conversation assistant. As output, the server produces a prompt sentence such as:

“The elderly resident says: ‘I feel a little tired today.’ The profile shows that the resident enjoys gardening and traveling and used to be a primary school teacher. The current mood is slightly tired but calm. As a conversation assistant, generate one short, gentle question (1-2 sentences) in polite Japanese that invites the resident to recall a pleasant memory related to gardening or travel. Avoid giving any medical advice or using complex vocabulary.”

### Step 10:

The server performs inference using the generative AI model to obtain conversation candidate information.

The server sends the prompt sentence to a generative AI model hosted locally or externally. As input, the server uses the prompt sentence from Step 9. The server tokenizes the prompt, converts tokens into embeddings, and processes the embeddings through the generative AI model, which may be a transformer-based language model with multiple attention layers and feed-forward networks. The model computes, layer by layer, attention-weighted representations and outputs probability distributions over the vocabulary for each next token. The server decodes these distributions using a decoding strategy such as nucleus sampling with a temperature parameter and a maximum length constraint. As output, the server obtains conversation candidate information in the form of generated text representing a proposed utterance or question to be spoken to the user.

### Step 11:

The server post-processes the generated conversation candidate information.

The server checks and refines the generated text before use. As input, the server uses the raw generated text from Step 10 and the constraints encoded in the context object and prompt sentence. The server scans the text for forbidden terms, inappropriate phrases, or violations of length and style constraints. The server may apply rule-based filters (for example, removing medical advice phrases) and, if necessary, truncate or regenerate portions of the text. As output, the server produces cleaned conversation candidate information that is safe and aligned with the system's style and content policies.

### Step 12:

The server determines a presentation timing for the conversation candidate information.

The server uses the presentation timing determination unit to decide when to present the generated text to the user. As input, the server uses acoustic data such as timestamps, silence durations, voice intensity values, and utterance boundary information derived from the audio information and conversation log, as well as emotion information from Step 6. The server calculates features such as current silence duration, recent speaking rate, and changes in emotion over time. The server applies a control logic, which may include rule-based conditions (for example, present only when silence>threshold) and a learned scoring function that outputs a presentation score. As output, the server determines a specific time point or a time window during which the conversation candidate information should be output to the user.

### Step 13:

The server converts the conversation candidate information into an audio signal.

The server invokes an audio output unit that uses a text-to-speech engine to synthesize speech. As input, the server uses the cleaned conversation candidate information from Step 11 and the user's voice and speed preferences from the profile database. The server passes the text to the text-to-speech engine, which converts characters or phonemes into acoustic features and then into waveform samples using a synthesis model such as a neural vocoder. The server sets parameters such as speech rate, pitch, and volume to match the user's needs. As output, the server produces a digital audio signal representing the spoken version of the conversation candidate information.

### Step 14:

The server transmits the synthesized audio signal and timing information to the terminal.

The server prepares the synthesized audio and timing control data for delivery. As input, the server uses the audio signal from Step 13 and the presentation timing from Step 12. The server encapsulates the audio data and timing metadata (for example, start time or playback delay) into network messages and sends them via the network interface. As output, the server provides the terminal with a complete playback package consisting of audio samples and control information for aligned reproduction.

### Step 15:

The terminal plays back the audio signal to the user at the determined timing.

The terminal receives the playback package from the server. As input, the terminal uses the synthesized audio data and the associated timing metadata from Step 14. The terminal stores the audio in a playback buffer and uses a clock or timer to align playback with the specified timing. The terminal then sends the audio samples to a digital-to-analog converter, drives the loudspeaker, and emits sound into the environment. As output, the terminal produces audible speech so that the user hears a natural question or statement generated from the conversation candidate information.

### Step 16:

The user responds to the audio output, and the interaction cycle continues.

The user listens to the spoken output from the terminal. As input, the user receives the audible speech produced in Step 15. In response, the user produces new spoken utterances, such as recalling a travel memory or talking about a hobby. As output, the user generates new speech signals in the environment, which are then captured by the terminal microphones and fed back into Step 1, thereby closing the interaction loop and enabling continuous, adaptive conversational support based on the generative AI model and the constructed prompt sentences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional conversation-support systems that operate on general-purpose computing platforms typically rely on a pipeline of speech recognition, shallow natural language understanding, static user profiles, and template-based response generation. In such systems, a processor generally treats surrounding speech as plain text, applies rule-based or simple statistical analysis to detect topics, and then selects generic suggestions from a predefined set. As a result, the generated conversation suggestions often fail to reflect subtle, real-time changes in user state such as tension, anxiety, or fatigue, and therefore provide limited assistance in helping a user to enter or maintain natural conversation. Furthermore, known architectures usually separate speech recognition, natural language processing, and emotion estimation into loosely coupled modules that do not fully exploit multimodal signals. For example, typical implementations either ignore biosignals (such as heart rate or motion) or process them independently from linguistic and acoustic features. This fragmented processing pipeline prevents the processor from generating a robust, fine-grained emotional state representation and degrades the quality and timing of conversation support. From a computer-technology standpoint, this results in suboptimal use of hardware resources and machine learning models, because the system does not integrate multimodal feature vectors in a unified manner for downstream decision-making.

In addition, generative artificial intelligence models are increasingly employed to generate natural language. However, conventional systems generally provide such models with static or minimally contextualized prompts that do not encode an integrated view of conversation context, user profile, and emotional state. Without a dynamically constructed prompt sentence that fuses these heterogeneous inputs, the generative model tends to produce conversation suggestions that are either too generic, misaligned with the user's interests, or inappropriate in tone relative to the current conversation atmosphere. This reflects a deficiency in how processors orchestrate data structures and control flows for prompt generation, and ultimately limits the technical performance of the text-generation pipeline.

Moreover, existing timing-control mechanisms are typically heuristic and based only on surface-level indicators, such as silence duration or keyword detection, without feedback from a learned emotional model or from historical outcomes of prior interventions. Consequently, the processor cannot systematically optimize when to present conversation suggestions in a way that reduces user cognitive load and improves user engagement. From a computing perspective, the system fails to close the loop between inference (emotion and context estimation) and policy (timing and content selection) in a data-driven manner, leading to inefficient use of machine learning outputs and suboptimal interaction strategies.

There is also a lack of mechanisms for a processor to learn, over multiple sessions, which combinations of prompt configuration, generated conversation seeds, and presentation timing are most effective for a particular user. Many conventional systems store user preferences only as static attributes, without recording structured associations between generated suggestions, emotional reactions, and subsequent conversation outcomes. This limits the system's ability to adapt model inputs and decision logic, and thus constrains the improvement of the underlying computer-implemented process over time.

Accordingly, there is a need for a computer-implemented conversation-support system in which a processor: (i) integrates acoustic, linguistic, and biosignal features into a multimodal emotion recognition model; (ii) dynamically constructs prompt sentences for a generative AI model based on topic information, user profile information, and an estimated emotional state; (iii) uses the generative AI model to generate and filter conversation seeds tailored to the user; (iv) controls the timing of presenting such seeds based on conversation dynamics and emotional trends; and (v) records the relationship between suggestions, timing, and emotional changes to improve subsequent processing. Such a system would not merely improve user experience, but would also improve the functioning of the computer system itself by providing a more effective and adaptive pipeline for multimodal inference, prompt generation, generative text processing, and timing control.

The specific processing by the specific processing unit 290 of the data processing device 12 in Example 2 is realized by the following means.

The present invention provides a server comprising a processor configured to acquire acoustic information representing surrounding speech by using an audio input unit and convert the acoustic information into character information by using a speech recognition unit; to analyze the character information by using a natural language processing unit so as to perform lexical analysis, syntactic analysis, semantic analysis, and emotion analysis, and to extract topic information of a conversation and linguistic emotion information; to store, in a storage unit, user attribute information including at least interest fields of a user, preference information, past conversation history, and preferred output style, and to read and update the user attribute information in association with an analysis result of the natural language processing unit by using a user profile management unit; to input, to a multimodal emotion recognition model, at least one of acoustic feature quantities based on the acoustic information, language feature quantities based on the character information, and biological feature quantities based on biological information acquired from a biological measurement apparatus, and to estimate an emotional state of the user and of at least one conversation participant by using an emotion estimation unit; to generate, by using a prompt generation unit, a prompt sentence including an instruction sentence and condition information for a generative artificial intelligence model, the prompt sentence being dynamically constructed based on the topic information and linguistic emotion information from the natural language processing unit, the user attribute information from the user profile management unit, and the emotional state from the emotion estimation unit; to execute, by using a conversation seed generation unit, the generative artificial intelligence model for natural language generation with the prompt sentence as input, and to generate at least one conversation seed including at least one of a topic suggestion sentence, a question sentence, and an introduction sentence for use by the user in a conversation; to determine, by using a timing control unit, a point in time or a time interval for presenting the conversation seed to the user, based on at least one of conversation text data from the natural language processing unit, the user attribute information from the user profile management unit, the emotional state from the emotion estimation unit, and, when necessary, a timing-evaluation prompt sentence for the generative artificial intelligence model; and to generate, by using a speech synthesis unit, speech synthesis text data in which speech parameters including at least speaking rate, pitch, and prosody are set based on the conversation seed generated by the conversation seed generation unit, a preferred speech characteristic included in the user attribute information from the user profile management unit, and the emotional state from the emotion estimation unit, to generate audio data from the speech synthesis text data by using a speech synthesis device, and to output the audio data to a terminal carried or worn by the user. This enables the server to implement an integrated, multimodal processing pipeline that dynamically constructs context-rich prompt sentences for a generative AI model, generates conversation seeds that are both content-appropriate and tone-appropriate, adaptively controls presentation timing based on conversation dynamics and emotional trends, and continuously updates user-specific data structures based on observed emotional responses, thereby improving the technical performance, adaptability, and efficiency of the computer-implemented conversation support.

The term “audio input unit” refers to a hardware and software component configured to capture acoustic signals from an environment, including at least one microphone and an interface for converting analog sound into digital audio data usable by a processor.

The term “speech recognition unit” refers to a hardware and software component configured to convert digital audio data into character information by applying one or more speech recognition algorithms, including at least an acoustic model and a language model.

The term “character information” refers to digital data representing recognized linguistic content of speech as sequences of symbols, such as characters, subword units, or words, suitable for natural language processing.

The term “natural language processing unit” refers to a hardware and software component configured to analyze character information by performing at least lexical analysis, syntactic analysis, semantic analysis, and emotion analysis to obtain structured linguistic information.

The term “lexical analysis” refers to processing that segments character information into tokens and assigns lexical properties, such as part-of-speech categories, to the tokens.

The term “syntactic analysis” refers to processing that determines grammatical relationships among tokens, including at least dependencies or phrase structures, to identify roles such as subject, object, and predicate.

The term “semantic analysis” refers to processing that determines meaning-related information of text, including at least semantic categories, semantic relations, and semantic representations of utterances.

The term “emotion analysis” refers to processing that estimates an emotional tendency of text, such as positive, negative, or neutral polarity and its intensity, based on lexical, syntactic, and contextual features.

The term “topic information” refers to data indicating a category or subject of conversation, derived from character information and its semantic representation, such as travel, work, sports, or entertainment.

The term “linguistic emotion information” refers to data indicating an emotional tendency and strength inferred from textual content, including labels and scores representing at least an affective state expressed by utterances.

The term “storage unit” refers to a memory component, such as a non-transitory computer-readable medium, configured to store user attribute information, model parameters, conversation logs, and control data.

The term “user attribute information” refers to structured data describing properties of a user, including at least interest fields, preference information, past conversation history, and preferred output style.

The term “interest fields” refers to categories of content or topics that a user prefers or is likely to engage with, such as music, travel, technology, or hobbies.

The term “preference information” refers to data describing user-specific preferences, including at least preferred topic types, preferred tone of suggestions, and preferred interaction style.

The term “past conversation history” refers to recorded data of previous conversation sessions involving the user, including at least conversation text data, topics, emotional states, and presented conversation seeds.

The term “preferred output style” refers to data specifying how information should be presented to a user, including at least language style, politeness level, and formatting or length of suggestions.

The term “user profile management unit” refers to a hardware and software component configured to store, read, and update user attribute information in association with analysis results, and to manage such information across multiple sessions.

The term “biological measurement apparatus” refers to a device configured to measure at least one physiological or behavioral parameter of a user, such as heart rate, heart rate variability, body movement, or skin conductance.

The term “acoustic feature quantities” refers to numerical descriptors extracted from audio data, including at least spectral features, prosodic features, pitch, energy, and temporal characteristics of speech.

The term “language feature quantities” refers to numerical descriptors derived from character information, including at least token embeddings, sentence embeddings, and other vector representations of text.

The term “biological feature quantities” refers to numerical descriptors derived from biological information, including at least heart-rate-related features, motion-level features, and other physiological indicators.

The term “multimodal emotion recognition model” refers to a machine learning model that receives two or more types of feature quantities, including at least acoustic feature quantities, language feature quantities, and biological feature quantities, and outputs an estimated emotional state.

The term “emotional state” refers to data representing degrees of at least one of multiple emotion dimensions, such as tension, anxiety, joy, fatigue, arousal, or positive affect, for a user or a conversation participant.

The term “emotion estimation unit” refers to a hardware and software component configured to input acoustic, language, and biological feature quantities into a multimodal emotion recognition model and to output an estimated emotional state.

The term “generative artificial intelligence model” refers to a machine learning model configured to generate natural language text based on an input condition, such as a prompt sentence, and implemented using at least one neural network.

The term “prompt sentence” refers to a text expression that includes at least an instruction sentence and condition information provided to a generative artificial intelligence model, and that constrains or guides the content, format, and tone of the generated text.

The term “prompt generation unit” refers to a hardware and software component configured to construct a prompt sentence dynamically based on topic information, linguistic emotion information, user attribute information, and an emotional state.

The term “conversation seed” refers to text information intended to be used by a user in conversation, including at least a topic suggestion sentence, a question sentence, or an introduction sentence.

The term “conversation seed generation unit” refers to a hardware and software component configured to execute a generative artificial intelligence model using a prompt sentence as input and generate at least one conversation seed.

The term “conversation text data” refers to character information representing recognized speech segments in a conversation, optionally annotated with timestamps, speaker identifiers, topics, and emotion labels.

The term “timing-evaluation prompt sentence” refers to a prompt sentence provided to a generative artificial intelligence model to obtain an evaluation or recommendation regarding a timing for presenting a conversation seed.

The term “timing control unit” refers to a hardware and software component configured to determine when to present a conversation seed to a user based on conversation text data, user attribute information, an emotional state, and optionally a response to a timing-evaluation prompt sentence.

The term “speech synthesis text data” refers to data that includes at least text to be spoken and associated speech parameters, and that serves as input to a speech synthesis device.

The term “speech parameters” refers to control values for speech synthesis, including at least speaking rate, pitch, and prosody characteristics such as intonation and emphasis.

The term “preferred speech characteristic” refers to a subset of user attribute information that defines a user's preference regarding synthesized voice, including at least voice type, tone, and general prosodic style.

The term “speech synthesis unit” refers to a hardware and software component configured to generate speech synthesis text data and to cause a speech synthesis device to convert the speech synthesis text data into audio data.

The term “speech synthesis device” refers to a computing component or module that receives speech synthesis text data and produces digital audio data representing synthesized speech.

The term “terminal” refers to a user-side information processing apparatus that is carried or worn by the user, including at least an audio output interface and a communication interface to receive audio data from a server.

The term “degree of liveliness” refers to a measure computed from conversation text data or audio activity indicating a level of interaction intensity, such as frequency of turns, overlap of speech, or variation in prosodic features.

The term “presentation timing” refers to a selected point in time or time window at which a conversation seed is provided to a user, including at least immediate presentation, presentation after a predetermined delay, or non-presentation.

The term “learning process” refers to processing in which associations among conversation seeds, presentation timings, and subsequent changes in emotional state are recorded and used to modify at least one of prompt sentence generation, conversation seed selection, or timing control in subsequent operations.

In one embodiment, a server, a terminal, and a user cooperate to implement the invention. The server is implemented as a general-purpose information processing apparatus comprising at least one central processing unit (CPU), a main memory, a non-transitory storage device, and a network interface. The server executes an operating system such as a server-class operating system and a plurality of application programs for speech recognition, natural language processing, multimodal emotion recognition, generative AI processing, timing control, and speech synthesis. The terminal is implemented as a user-side information processing apparatus, such as a smartphone, a wearable device, or an earphone-type device, comprising at least one microphone, at least one speaker or earphone interface, one or more biological sensors (for example, a heart-rate sensor and a motion sensor), a processor, a memory, and a wireless network interface. The user carries or wears the terminal and interacts with the system in real time.

The server uses its processor and memory to execute a program that implements a set of logical units corresponding to the speech recognition unit, natural language processing unit, user profile management unit, emotion estimation unit, prompt generation unit, conversation seed generation unit, timing control unit, and speech synthesis unit. Each unit may be implemented as one or more software modules organized as services in a modular application architecture. For example, the server may execute a speech-recognition service implemented with a deep-learning toolkit, an NLP service implemented with a natural language processing library, a multimodal emotion recognition service implemented with a neural network library, a generative-text service interfacing with a generative AI model, and a TTS service interfacing with a speech synthesis engine.

The terminal uses its processor and operating system to run a client application that controls microphone access, sensor access, network communication, local buffering, and audio playback. The terminal uses an audio input API, such as a platform audio capture API, to acquire analog acoustic signals through the microphone and convert them into digital PCM data (for example, 16 kHz, 16-bit, mono). The terminal uses a digital signal processing library, such as a general-purpose DSP library or an audio processing library, to perform noise suppression, automatic gain control, and band-pass filtering that emphasizes human voice ranges. This processing reduces environmental noise and improves the signal-to-noise ratio of speech content, thereby improving downstream recognition accuracy and reducing computational load on the server by delivering more relevant data.

The terminal uses operating system sensor APIs to acquire biological information such as heart rate, heart rate variability, and motion intensity. The terminal associates timestamps with both the audio data and the biological data, and stores them in a structured data object. The terminal transmits this object to the server using a streaming protocol, such as a WebSocket or HTTP/2-based protocol, which allows continuous, low-latency communication.

The server receives the audio and biological data via the network interface and stores them in a reception buffer in main memory. The server then uses a digital signal processing module implemented in a numerical computation library (such as a general numerical library) to process the audio segments. The server applies pre-emphasis, windowing, and fast Fourier transform (FFT) operations to derive spectral information, then computes acoustic feature quantities such as Mel-frequency cepstral coefficients (MFCCs), pitch, energy, and speaking rate. These features are expressed as numerical vectors in a fixed-dimensional space.

The server uses the speech recognition unit to convert audio-derived feature vectors into character information. The speech recognition unit uses an acoustic model and a language model implemented, for example, with a neural network-based acoustic model and a statistical or neural language model. The acoustic model may be realized as a deep neural network trained with a supervised learning algorithm on pairs of acoustic features and phonetic labels. The loss function for training can include a cross-entropy loss for frame-level phone classification, or a connectionist temporal classification (CTC) loss for sequence-level training. The language model may be implemented as an n-gram model or as a transformer-based sequence model trained to predict the next token given previous tokens. During inference, the server combines probabilities from the acoustic model and the language model using beam search to output the most probable sequence of text tokens. This integrated decoding improves recognition accuracy compared to simpler pipelines, thereby reducing the error rate of recognized character information and improving the quality of downstream processing.

The server uses the natural language processing unit to analyze the character information. The server uses a morphological analyzer to tokenize the text into words or subword units and to assign part-of-speech tags. The server then uses a syntactic parser to derive dependency structures or phrase structures, specifying relations such as subject, object, and predicate. The server uses a semantic model, such as a transformer-based encoder, to convert each sentence into a high-dimensional semantic embedding vector. These embeddings are used by a topic classification sub-module to assign topic information such as “travel,” “work,” or “sports.” The topic classifier may be implemented as a feedforward neural network trained on labeled data with a cross-entropy loss to minimize misclassification. The server also uses a sentiment or emotion classification model to derive linguistic emotion information. This model is trained to output labels such as positive, negative, and neutral, and to assign probability scores to each label. By using semantic embeddings and trained classifiers, the system achieves higher precision and robustness in topic and emotion classification than simple keyword-based approaches, thereby improving the reliability of the computed contextual information that is used in later stages.

The server uses the user profile management unit to store and update user attribute information in a relational or document-oriented database. The server maintains tables or collections that include fields for user identifiers, interest fields, preference information (for example, preferred tone and voice style), past conversation sessions, and recorded associations between presented conversation seeds and observed emotional responses. The server reads this information by querying the database indices and uses it to construct user-specific context. The server writes new information by inserting or updating records that reflect new sessions, newly generated conversation seeds, and updated preference estimates. The server uses the emotion estimation unit to integrate acoustic features, language features, and biological features into a multimodal emotion recognition model. In one embodiment, the server implements the model as a neural network that has separate sub-networks for each modality (for example, a convolutional or recurrent sub-network for acoustic features, a transformer or recurrent sub-network for text embeddings, and a feedforward or recurrent sub-network for biological features). The server uses a fusion layer that concatenates or applies attention across modality-specific representations and then uses fully connected layers to output an emotional state vector. The output dimensions can represent, for example, tension, anxiety, joy, fatigue, and general positive affect. The model is trained with supervised learning using labeled data that associates feature sequences with emotional labels or continuous scores. The server uses a loss function such as mean squared error for regression or cross-entropy for multi-label classification, and updates weights by a gradient-based optimizer. This multimodal design allows the server to exploit correlations among audio, text, and biosignals that are not easily inferred by humans in real time, thereby producing more accurate and more stable emotion estimates. The improved emotional-state estimation leads directly to more precise timing and content selection for conversation support, thereby improving the functioning of the overall computing pipeline.

The server uses the prompt generation unit to construct a prompt sentence for a generative AI model. The server first constructs an integrated context object, including at least: (i) a recent conversation summary, (ii) topic information, (iii) user attribute information, and (iv) an emotional-state description. The server may use a summarization algorithm implemented with a transformer encoder-decoder model to compress the recent conversation text into a short summary. The generative AI model used in this embodiment may be a transformer-based large language model trained on a large corpus of text using a next-token prediction objective; the model is not restricted to a specific commercial implementation, but is characterized by multiple self-attention layers, feedforward layers, and positional encoding components.

The server formats the integrated context as a prompt sentence. For example, the server can generate the following prompt sentence:

“You are an assistant that supports friendly small talk.

Here is a summary of the recent conversation: ‘They are talking about recent domestic trips and recommended sightseeing spots.’

The current conversation theme is ‘travel’.

The user's interests are ‘hot springs and local food’, and the current emotional state is ‘high tension, medium anxiety, and low positive affect’.

Please generate:
1. Two short, polite questions that the user can ask the others about travel, especially related to hot springs or local food.
2. One short introduction phrase that allows the user to start talking about their love for hot springs or local food.

Output should be in natural Japanese, casual but polite spoken style, each suggestion consisting of one or two short sentences.”

The server injects dynamically computed values (such as the conversation summary and emotional-state description) into the template at runtime. This dynamic prompt construction causes the generative AI model to condition its generation on a multi-faceted representation of the current situation. This is more than simply automating human selection of questions, because the prompt-generation logic structures high-dimensional contextual data and controls the generative model in a manner that a human cannot efficiently replicate in real time. Furthermore, the server uses structured prompt patterns tailored for different functions, such as mood change or timing decision, thereby improving controllability and reducing variability of generative outputs.

The server uses the conversation seed generation unit to perform inference with the generative AI model. The server passes the prompt sentence as input text to the model's decoding interface and uses a decoding strategy such as top-k sampling, nucleus sampling, or constrained beam search. The server may specify parameters such as temperature (controlling randomness), maximum output length, and forbidden token lists. The generative AI model produces output text, which the server segments into individual conversation seed candidates using delimiters (for example, line breaks or numbering).

The server uses a post-processing pipeline to filter and rank the conversation seed candidates. The server uses a safety classifier or rule-based filter to exclude candidates that contain offensive or disallowed expressions. The server computes embedding vectors for each candidate using the same or a similar language model as used in the NLP unit, and compares these embeddings with the embeddings of the current topic and with interest-related keywords using cosine similarity. The server computes a composite score that combines topic relevance, user-interest alignment, and, optionally, stylistic conformity with user preferences. This scoring function may include weighted terms and thresholds that are tuned experimentally. The server selects one or more top-scoring candidates to serve as final conversation seeds. This selective process reduces the risk of inappropriate or irrelevant suggestions and represents a non-trivial enhancement over simple “first response” outputs of generative models, making the computer system's behavior more reliable and predictable.

The server uses the timing control unit to determine when to present the selected conversation seed. The server analyzes conversation text data and emotional-state data over a temporal window. The server computes features such as the average utterance interval, the length of the most recent silence, the rate of speaker turns, and a measure of conversation “liveliness” (for example, based on overlapping speech or variance of prosodic features). The server also analyzes trends in emotional dimensions, such as whether tension or anxiety is increasing or decreasing. The server applies rules or learned policies that map this feature vector to one of multiple timing categories: immediate presentation, presentation after a specified delay (for example, 2 to 5 seconds), or non-presentation. In a variation, the server generates a timing-evaluation prompt sentence describing recent conversation logs and emotional states, and uses the generative AI model to suggest a suitable timing option. In this case, the server still uses deterministic logic to integrate the model's suggestion with rule-based conditions, thereby maintaining overall control flow.

The server uses the speech synthesis unit to transform text-based conversation seeds into audio data. The server selects a TTS voice based on preferred speech characteristics stored in the user profile and sets speech parameters such as speaking rate, pitch, and prosody according to the current emotional state. For example, when tension is high, the server sets a slower speaking rate and lower pitch to produce a calming effect; when the conversation is lively and the user is relaxed, the server sets a faster speaking rate and slightly higher pitch. The server constructs speech synthesis text data that includes the text content, the voice identifier, and numerical values for prosodic parameters. The server invokes a TTS engine, which may be a neural TTS model such as a sequence-to-spectrogram model followed by a neural vocoder. The engine generates an audio waveform, which the server optionally encodes with an audio codec to reduce bandwidth. The server sends the audio data and, if needed, timing metadata to the terminal.

The terminal receives the audio data and timing metadata, buffers the data locally, and uses audio playback APIs to output the synthesized suggestion through the speaker or earphones at the designated time. The terminal may adjust volume levels or temporarily pause other audio streams to ensure that the user can hear the suggestion clearly. The user then hears a context-sensitive, emotionally aware suggestion in real time and may choose to adopt it in the conversation.

The server records, in the user profile management unit, the content of the conversation seed, the selected presentation timing, and the emotional-state trajectory before and after the presentation. The server updates user-specific parameters such as weights on topic relevance, interest alignment, or preferred phrasing patterns. For example, if conversation seeds that include gentle, self-disclosing introductions consistently correlate with reductions in tension, the server increases a weight associated with such patterns in the scoring function and adjusts future prompt sentences to request similar structures. This forms a feedback loop in which the processor improves the internal control logic of the generative AI model's usage and the timing control policy over time.

This architecture yields several technical effects that go beyond mere automation of human tasks. By using multimodal feature integration in the emotion recognition model, the server reduces misclassification of emotional states and thereby lowers the rate of inappropriate interventions. This improved accuracy leads to fewer redundant or mistimed suggestions, which reduces unnecessary communication between the server and terminal, thereby reducing network load. By dynamically constructing prompt sentences that encode structured, high-dimensional context, the server controls the generative AI model in a fine-grained manner, which reduces the need for repeated generation cycles and manual corrections, improving computational efficiency. By aggregating and reusing associations between seeds, timing, and emotional outcomes, the server adapts its internal parameters and data structures, which improves the system's precision and responsiveness for that user in subsequent sessions.

In another embodiment, the server implements alternative model architectures. For the speech recognition unit, the server may use an end-to-end transformer-based model trained with a sequence-to-sequence objective. For the emotion estimation unit, the server may use attention-based fusion instead of simple concatenation, where an attention mechanism learns to weight each modality differently depending on context. For the generative AI model, the server may deploy a smaller, domain-specific generative model on-premises when network connectivity is constrained, while in other cases the server may access a more capable cloud-based model. For the timing control unit, the server may use a reinforcement learning framework in which a policy network is trained to select presentation timings that maximize a reward function defined over emotional improvements and user engagement, using recorded interactions as experience data.

In another embodiment, the terminal performs some preprocessing locally to reduce bandwidth and latency. For example, the terminal may compute simple acoustic features and downsample sensor data before sending it to the server. The server can adapt its processing pipeline depending on whether it receives raw data or preprocessed features. The system thus supports multiple deployment configurations while preserving the fundamental structure of integrating multimodal emotion recognition, prompt sentence construction, generative AI-based conversation seed generation, timing control, and speech synthesis.

By integrating these components in the described manner, the server and terminal together constitute a specific, improved machine configuration that processes multimodal data, controls a generative AI model with dynamically constructed prompt sentences, and outputs context-sensitive, emotionally aware audio suggestions. This configuration improves the operation of the computer-based system itself in terms of recognition accuracy, emotional-state estimation precision, generative output relevance, timing optimization, and resource efficiency, and provides a concrete technological solution that cannot be achieved by conventional systems that merely automate human conversation-planning tasks.

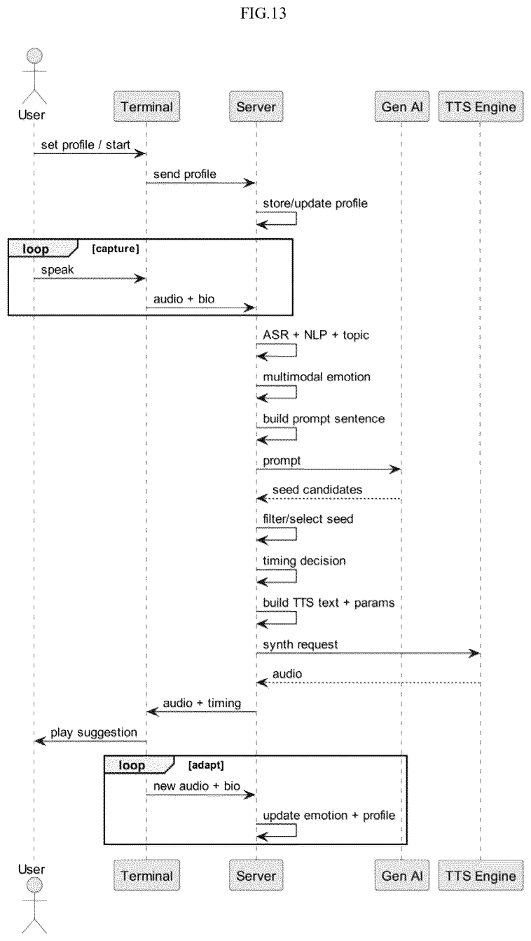

The following describes the processing flow using FIG. 13.

### Step 1:

User configures profile and activates conversation support mode.

User operates the application on the terminal to input interest fields, preferred topics, and preferred voice tone.

Input: User's selections and text inputs on the terminal UI.

Terminal validates the inputs, converts them into a structured profile object (e.g., a key-value map), and temporarily stores the object in local memory.

Output: Structured user profile object stored in the terminal.

### Step 2:

Terminal sends user profile to the server.

Input: Structured user profile object stored in the terminal.

Terminal serializes the profile into a message (for example, JSON) and transmits it through a network interface using a communication library.

Server receives the message, parses the serialized data into an internal data structure, and associates the profile with a user identifier.

Output: User attribute information stored in a server-side user profile database.

### Step 3:

Terminal acquires and pre-processes audio.

Input: Analog acoustic signals from the environment captured by the microphone.

Terminal uses the audio capture API to sample the analog signals and convert them into digital PCM frames (e.g., 16 kHz, 16-bit, mono).

Terminal applies noise suppression, gain control, and band-pass filtering using a DSP library to enhance speech components and attenuate background noise.

Terminal groups successive frames into fixed-length audio chunks and annotates each chunk with a timestamp and a session identifier.

Output: Pre-processed, time-stamped audio chunks stored in terminal memory.

### Step 4:

Terminal acquires biological sensor data and binds it to audio chunks.

Input: Biological signals such as heart rate and motion data obtained from built-in or connected sensors.

Terminal reads sensor values at regular intervals via sensor APIs and attaches timestamps to each reading.

Terminal aligns sensor readings with the time ranges of audio chunks by matching timestamps and aggregates sensor values within each audio chunk's interval (e.g., computing mean heart rate and motion level).

Output: Combined data objects, each including one audio chunk and corresponding aggregated biological feature values.

### Step 5:

Terminal transmits multimodal data to the server.

Input: Combined data objects containing audio chunks and associated biological data.

Terminal serializes each combined object into a transmission format and sends the sequence of objects to the server via a persistent network connection.

Server receives the objects and stores them in an input buffer in main memory, indexing them by session ID and timestamp.

Output: Buffered multimodal data available for server-side processing.

### Step 6:

Server extracts acoustic features from audio chunks.

Input: Digital audio chunks from the input buffer.

Server performs pre-emphasis, framing, and windowing on each audio chunk using a signal processing module, then computes FFTs for each frame.

Server converts spectral data into Mel-scale filter bank energies and calculates MFCCs, pitch, energy, and other prosodic features, thereby transforming raw waveform data into numerical feature vectors.

Output: Sequences of acoustic feature vectors associated with each audio chunk.

### Step 7:

Server performs automatic speech recognition (ASR).

Input: Acoustic feature sequences associated with each audio chunk.

Server feeds the feature sequences into an acoustic model and a language model, and performs decoding using a beam search algorithm to map feature sequences to token sequences.

Server converts the recognized tokens into character information (text strings), attaches timestamps, and optionally speaker identifiers inferred from diarization logic.

Output: Conversation text data representing recognized utterances with timing and metadata.

### Step 8:

Server performs linguistic analysis and topic classification.

Input: Conversation text data from the ASR process.

Server executes a morphological analysis to tokenize text and assign part-of-speech tags, then runs a syntactic parser to determine grammatical relationships.

Server uses a semantic encoding model to transform each sentence into a vector representation and passes these vectors to a topic classifier to assign topic labels such as “travel” or “work.”

Output: Annotated conversation text data including tokens, syntactic structure, semantic embeddings, and topic information.

### Step 9:

Server estimates linguistic emotion from text.

Input: Annotated conversation text data and semantic embeddings.

Server feeds each sentence or embedding vector into a sentiment/emotion classifier that outputs emotion labels (e.g., positive, negative, neutral) and corresponding scores.

Server attaches these labels and scores to the utterance records and aggregates them into a time series of linguistic emotion information over the session.

Output: Conversation text data enriched with linguistic emotion information and a linguistic emotion timeline.

### Step 10:

Server computes multimodal emotion state.

Input: Acoustic feature sequences, linguistic emotion information, semantic embeddings, and biological feature values.

Server synchronizes these features by aligning their timestamps and constructs multimodal feature vectors for each time window.

Server inputs the multimodal vectors into a multimodal emotion recognition model that combines modality-specific sub-networks and a fusion layer to output an emotional state vector.

Output: Time-series emotional state data representing dimensions such as tension, anxiety, joy, and fatigue for the user and, if applicable, other participants.

### Step 11:

Server retrieves and updates user profile information.

Input: User identifier and current session context (topic, emotional state).

Server queries the user profile database to read stored user attribute information, including interest fields, preferences, and records of past sessions.

Server merges the newly computed emotional state and conversation context with existing profile entries, and, if necessary, updates stored statistics such as frequency of successful suggestions for specific topics or tones.

Output: Updated user attribute information and a consolidated context object describing the current user state and history.

### Step 12:

Server generates an integrated context description.

Input: Topic information, conversation summary, user attribute information, and current emotional state.

Server uses a summarization algorithm to condense recent conversation text into a short summary, then combines this summary with topic labels, interest fields, and emotional-state descriptions in a structured internal object.

Server converts the internal object into human-readable strings that will be embedded into a prompt sentence, ensuring that all relevant information (e.g., interests and tension level) is explicitly represented.

Output: Integrated context description containing text strings for summary, topic name, interests, and emotional-state explanation.

### Step 13:

Server constructs a prompt sentence for the generative AI model.

Input: Integrated context description (summary, topic, interests, emotional state) and configuration about required output format.

Server applies a template for prompt generation, inserting the context strings into designated placeholders and appending instructions specifying the number, form, and style of desired conversation seeds.

Server, for example, constructs a prompt sentence such as:

“You are an assistant that supports friendly small talk.

Here is a summary of the recent conversation: ‘They are talking about recent domestic trips and recommended sightseeing spots.’

The current conversation theme is ‘travel’.

The user's interests are ‘hot springs and local food’, and the current emotional state is ‘high tension, medium anxiety, and low positive affect’.

Please generate:
1. Two short, polite questions that the user can ask the others about travel, especially related to hot springs or local food.
2. One short introduction phrase that allows the user to start talking about their love for hot springs or local food.

Output should be in natural Japanese, casual but polite spoken style, each suggestion consisting of one or two short sentences.”

Output: Fully constructed prompt sentence ready to be input to the generative AI model.

### Step 14:

Server generates conversation seed candidates using the generative AI model.

Input: Prompt sentence specifying context and generation instructions.

Server sends the prompt sentence to the generative AI model and invokes the model's generation function with specified decoding parameters (e.g., maximum length, sampling strategy).

Server receives the generated text, splits it into separate suggestions based on markers such as line breaks or numbering, and treats each suggestion as a candidate conversation seed.

Output: List of conversation seed candidate texts with raw content from the generative AI model.

### Step 15:

Server filters and selects conversation seeds.

Input: List of candidate conversation seeds and current context (topic, interests, emotional state).

Server runs a safety filter to remove candidates containing inappropriate expressions, using pattern matching or a classifier.

Server computes embedding vectors for each remaining candidate and compares them with topic embeddings and interest-related embeddings using similarity measures.

Server assigns a composite score to each candidate based on safety status, topic relevance, and interest alignment, then selects one or more top-scoring candidates as final conversation seeds.

Output: Selected conversation seed text or texts suitable for presentation to the user.

### Step 16:

Server determines the timing for presenting conversation seeds.

Input: Recent conversation text data, emotional state timeline, and selected conversation seeds.

Server computes features such as current silence duration, average utterance interval, and changes in tension and anxiety levels, and evaluates whether the moment is a pause or an active exchange.

Server applies decision rules and, if configured, uses a timing-evaluation prompt sentence with the generative AI model to obtain a recommendation, then combines the results to classify timing as immediate, delayed, or skipped.

Output: Timing decision specifying when and whether to present each conversation seed.

### Step 17:

Server prepares speech synthesis text data.

Input: Selected conversation seeds, timing decision, user's preferred speech characteristics, and current emotional state.

Server determines speech parameters (speaking rate, pitch, prosody) based on preferences and emotional-state values, for example lowering pitch and reducing speed when tension is high.

Server creates speech synthesis text data containing the conversation seed text and associated speech parameters formatted for the speech synthesis engine.

Output: Speech synthesis text data objects configured for TTS processing.

### Step 18:

Server synthesizes audio for conversation seeds.

Input: Speech synthesis text data objects.

Server invokes the TTS engine, providing both text and prosodic parameters, and the engine generates audio waveforms representing spoken versions of the conversation seeds.

Server optionally encodes the waveforms using an audio codec and attaches playback metadata such as start time or delay seconds.

Output: Encoded audio data with playback control information for delivery to the terminal.

### Step 19:

Terminal receives and plays back synthesized suggestions.

Input: Encoded audio data and playback control information from the server.

Terminal decodes the audio stream if necessary, stores it in a local buffer, and schedules playback based on the specified timing.

Terminal uses its audio output API to play the audio through earphones or speakers, adjusting volume if required so that the user can clearly hear the suggestion.

Output: Auditory presentation of the conversation seed to the user at the selected timing.

### Step 20:

User reacts to suggestions and system updates the profile.

Input: Audio suggestion perceived by the user and subsequent user behavior and emotional state.

User may adopt the suggested phrase or question in the ongoing conversation, leading to new speech that the terminal captures as part of subsequent audio streams.

Server processes the new audio and emotion data through the same pipeline, then compares emotional-state values before and after the suggestion to estimate the effectiveness of the seed and timing.

Server records the association among the conversation seed, its timing, and the observed emotional change in the user profile database and adjusts internal parameters for prompt generation, seed selection, and timing control accordingly.

Output: Updated user attribute information reflecting learned effectiveness patterns for future sessions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional conversation support systems typically convert user speech into text and then select fixed responses or simple template-based topics. Such systems generally ignore multimodal information such as acoustic features and facial expressions, and they treat user profiles as static records that are not tightly coupled to the user's evolving emotional state. As a result, these systems often fail to present conversation topics that are timely, emotionally appropriate, and truly personalized to each user.

From a computer technology standpoint, existing architectures suffer from several technical limitations. First, audio capture and speech recognition pipelines are usually optimized only for transcription accuracy and do not expose structured timing signals, such as utterance boundaries and silence intervals, in a form that downstream modules can exploit for fine-grained control of interaction timing. Second, emotion recognition, when present at all, is frequently implemented as an isolated module that either relies only on text or only on acoustic cues, without a unified multimodal representation or time-series analysis of emotional trends. Third, user profile management is commonly implemented as a simple database of static attributes and preferences, without continuous, algorithmic updating based on the interplay between conversation topics and observed emotional reactions.

Furthermore, typical use of generative AI models in dialog systems is limited to naively feeding the latest user utterance to a large language model and returning its output. Such use does not leverage the full state of the system specifically, long-term profile data, multimodal emotion estimates, and structured timing signals to systematically construct input instructions. As a consequence, the generative AI model cannot be relied upon to produce conversation topics that are aligned with user-specific emotional needs, nor can it assist in determining when the system should speak, remain silent, or offer empathic utterances.

These shortcomings manifest as technical inefficiencies and degraded system behavior. The dialog manager must implement ad hoc heuristics for timing and topic selection, leading to brittle behavior, unnecessary computation, and frequent user-perceived failures (for example, interruption at inappropriate moments or emotionally mismatched topics). There is therefore a need for an improved computer-implemented architecture that (i) integrates multimodal emotion estimation with dynamic profile management, (ii) systematically encodes this integrated state into prompt sentences for a generative AI model, and (iii) uses the model not only for content generation but also for timing recommendations, in order to improve the technical performance and controllability of the conversation support system.

The specific processing by the specific processing unit 290 of the data processing device 12 in Application Example 2 is realized by the following means.

The present invention provides a server comprising a processor configured to acquire environmental audio, perform preprocessing and noise suppression to generate normalized digital audio data, compute acoustic features, and apply a speech recognition algorithm to obtain time-stamped character data and utterance segment information; a natural language processing engine configured to perform morphological, syntactic, semantic, and topic analyses of the character data to extract conversation themes, intentions, related concepts, and keywords; a profile management component configured to store, for each user, profile information including attributes, preferences, health-related information, past conversation history, and emotion history, and to dynamically update preferences and topic-emotion relationships based on the natural language processing analysis results and the emotion history; an emotion estimation model configured to receive acoustic features, character data, and, when available, expression features derived from image or motion data, and to estimate a multidimensional emotion state together with temporal change tendencies, and to store the estimated emotion state in association with the profile information; a prompt generation component configured to construct, from the profile information, conversation analysis results, and the estimated emotion state and trends, a prompt sentence in a natural language format as an instruction to a generative AI model; an integration component configured to call the generative AI model using the prompt sentence to obtain multiple conversation topic candidates and corresponding utterance sentences, to evaluate a suitability score of each candidate with respect to the profile information and the emotion state, and to select at least one conversation topic and utterance sentence; a timing control component configured to determine, on the basis of the utterance segment information, silence durations, and the estimated emotion state, a presentation time or time interval for the selected conversation topic, to optionally generate an additional instruction sentence including recent conversation transcription and emotion state, to obtain timing recommendation information from the generative AI model, and to integrate the recommendation information with internal timing rules to control the presentation timing; and a speech synthesis and output control component configured to apply a speech synthesis algorithm to the selected utterance sentence with speech parameters adapted to the estimated emotion state, to generate an audio signal, and to cause an output device to present the audio signal at the determined timing. This enables the computer system to improve the technical quality of dialog management by tightly coupling multimodal emotion estimation, dynamic profile updating, and generative AI model prompting, thereby generating conversation topics and presentation timings that are algorithmically optimized and personalized in real time, reducing inappropriate interruptions and emotionally mismatched content, and enhancing the overall robustness and efficiency of the conversation support processing.

The term “environmental sound” refers to any audio signal present in a user's surrounding space, including user speech, caregiver speech, background noise, and other ambient sounds, which is captured by an audio input unit for processing by the system.

The term “audio input unit” refers to a hardware and software component that includes at least one acoustic sensor and associated circuitry or driver software, and that acquires an analog audio signal from the environment for subsequent conversion into digital audio data.

The term “digital audio data” refers to a numerical representation of an audio signal obtained by sampling an analog audio signal at a predetermined sampling frequency and quantizing it at a predetermined bit depth, typically in pulse code modulation format.

The term “preprocessing” refers to a sequence of signal processing operations, including at least one of resampling, normalization, filtering, and framing, that is applied to digital audio data in order to prepare the data for subsequent analysis such as speech recognition or feature extraction.

The term “noise suppression” refers to a digital signal processing technique that attenuates or removes unwanted background components from digital audio data, using at least one of spectral subtraction, adaptive filtering, or model-based denoising.

The term “acoustic feature quantity” refers to a numerical descriptor derived from digital audio data, including at least one of a cepstral coefficient, spectral measure, fundamental frequency, energy value, speech rate indicator, or pause duration measure, which characterizes properties of the audio signal relevant to speech or emotion analysis.

The term “speech recognition algorithm” refers to a computational procedure, implemented by software and executed on a processor, that converts digital audio data into character data by mapping acoustic features to linguistic units using at least one acoustic model and one language model.

The term “character data” refers to a machine-readable sequence of textual symbols, such as letters, numerals, and punctuation, representing the linguistic content recognized from an audio signal.

The term “time information” refers to temporal metadata associated with character data, including at least one of a start time, an end time, and an utterance duration, expressed relative to a reference clock or time axis.

The term “utterance section information” refers to data indicating contiguous segments of speech in an audio signal, including boundaries between spoken segments and silent intervals, and optionally including identifiers for each utterance segment.

The term “natural language processing” refers to a class of computational techniques that analyze character data to determine linguistic structure and meaning, including at least morphological analysis, syntactic analysis, semantic analysis, and topic classification.

The term “morphological analysis” refers to a process that segments character data into tokens and assigns part-of-speech or other lexical attributes to each token.

The term “syntactic analysis” refers to a process that determines grammatical relations among tokens in character data, including at least dependency relations between heads and dependents in an utterance.

The term “semantic analysis” refers to a process that derives meaning representations from character data, including at least the identification of predicates, arguments, and semantic roles.

The term “topic classification” refers to a process that assigns one or more thematic category labels to an utterance, based on its linguistic content, according to a predefined topic taxonomy.

The term “conversation theme” refers to a category indicating a high-level subject of an utterance, such as health, family, hobbies, memories, or other living activities.

The term “utterance intention” refers to an inferred communicative purpose of an utterance, such as expressing a feeling, asking a question, reporting a fact, or making a request.

The term “related concept” refers to a semantic entity, such as an object, place, person, or event, that is extracted from an utterance and is associated with a conversation theme or with user preferences.

The term “keyword” refers to a token or phrase in character data that has been identified as salient for at least one of topic classification, profile updating, or prompt sentence generation.

The term “profile information” refers to a structured collection of data associated with a user, including at least attribute information, preference information, health-related information, past conversation history, and emotion history.

The term “attribute information” refers to user-specific static or slowly changing characteristics, including at least age, biological sex, and familial status, that are stored as part of the profile information.

The term “preference information” refers to user-specific indications of topics, activities, or entities that the user tends to favor or disfavor, represented as weights, scores, or flags in the profile information.

The term “health-related information” refers to data describing a user's physical or mental condition, including at least medical conditions, sleep patterns, or functional limitations, which is stored in the profile information.

The term “past conversation history” refers to stored records of prior interactions between the user and the system or third parties, including at least utterance texts, timestamps, themes, and system outputs.

The term “emotion history” refers to stored records of estimated emotion states associated with past utterances or time intervals, including numerical scores and temporal patterns for multiple emotion components.

The term “topic-emotion relationship” refers to an association stored in the profile information that describes a correlation between the occurrence of a particular conversation theme or keyword and a change in one or more emotion components.

The term “emotion estimation model” refers to a computational model, typically realized as a machine learning or statistical model, that accepts multimodal input features and outputs an estimate of a multidimensional emotion state and its temporal change tendency.

The term “expression feature” refers to a numerical descriptor derived from visual or motion data of a user, including at least facial expression indicators, body posture indicators, or gesture indicators, used for emotion estimation.

The term “multidimensional emotion state” refers to a representation of a user's psychological state as a vector or set of values corresponding to multiple emotion components such as joy, relief, anxiety, loneliness, anger, and boredom.

The term “temporal change tendency” refers to an indication of how one or more components of the multidimensional emotion state evolve over time, including at least increasing trends, decreasing trends, or periodic patterns.

The term “prompt sentence” refers to a structured instruction in a natural language format generated by the system to be input to a generative AI model, the instruction including at least profile information, conversation analysis results, and emotion state information.

The term “generative AI model” refers to a trained information processing model that, given an input such as a prompt sentence, generates new text, including at least conversation topics and utterance sentences, based on learned probabilistic patterns.

The term “conversation topic candidate” refers to a proposed high-level subject for future dialog, generated by the generative AI model and expressed as text suitable for use in interaction with the user.

The term “utterance sentence” refers to a textual representation of a specific phrase or sentence that the system may output as part of a conversation, corresponding to a conversation topic candidate.

The term “suitability score” refers to a numerical value computed by the system that quantifies the degree of alignment of a conversation topic candidate or utterance sentence with the profile information and current emotion state of the user.

The term “timing control” refers to a process that determines when the system should present a conversation topic or utterance sentence, based on at least utterance section information, silence durations, emotion state, and, optionally, recommendations from a generative AI model.

The term “silence duration” refers to a measured time interval between the end of one utterance and the start of a subsequent utterance in an audio signal.

The term “timing recommendation information” refers to data returned by a generative AI model in response to an instruction sentence, indicating when or under what conversational conditions the system should output a response.

The term “internal timing rule” refers to a predefined or learned algorithmic rule executed by the system to evaluate conversational timing, independent of external model recommendations.

The term “speech synthesis algorithm” refers to a computational procedure that converts textual utterance sentences and associated speech parameters into an audio signal suitable for playback as synthetic speech.

The term “speech parameter” refers to a control value used by a speech synthesis algorithm, including at least pitch, speaking rate, volume, and voice quality, and which may be adapted based on the estimated emotion state.

The term “output device” refers to a hardware component, such as a loudspeaker or headphone transducer, used to present audio signals generated by the system to the user.

In one embodiment, a conversation support system is implemented as a distributed architecture including a server and at least one terminal connected via a communication network. The server executes multiple software modules on an information processing apparatus including at least one multi-core central processing unit and, in some embodiments, at least one graphics processing unit. The terminal is implemented as a mobile information terminal, a stationary information terminal, or an embedded appliance installed in a care facility.

The terminal acquires physical signals from the real environment. The terminal includes a microphone, a loudspeaker, and optionally a camera, all controlled through an operating system such as a mobile operating system or an embedded operating system. The terminal converts analog audio signals received at the microphone into digital audio data through an analog-to-digital converter on an audio interface. The terminal executes audio processing software to buffer the digital audio data in memory, to perform lightweight noise reduction using, for example, spectral subtraction based on frame-wise power spectral density estimates, and to packetize the processed audio frames together with metadata such as timestamps and terminal identifiers. The terminal transmits the resulting packets over a wireless or wired network interface using a transport protocol such as a secure transport protocol.

The server receives the audio packets through a network interface and stores the digital audio data in main memory. The server executes an audio preprocessing module implemented with an audio processing library such as a general-purpose signal processing library. The server normalizes the amplitude of the audio data to a target root-mean-square level, resamples the data if necessary to a standard sampling rate, and applies a noise suppression model. In one embodiment, the server applies a deep neural network-based denoiser trained on paired noisy and clean speech data, where the model architecture is a convolutional encoder-decoder network with skip connections, operating on short-time Fourier transform magnitude spectra. The server thereby reduces background noise and reverberation artifacts that would degrade recognition accuracy.

The server applies a speech recognition engine to the preprocessed audio. In one embodiment, the server uses a continuous speech recognition engine implemented using a hybrid acoustic-language model architecture or an end-to-end model. The server computes short-time Fourier transform spectra for overlapping frames, derives acoustic features such as Mel-frequency cepstral coefficients or filter-bank energies, and feeds these features into an acoustic model realized as a deep neural network. The server decodes the most likely sequence of phonetic or subword units, and further maps these to character sequences using a statistical language model or a sequence-to-sequence decoder. The server outputs character data together with time information including, for each token, an estimated start and end time on the audio time axis. The server also identifies utterance sections by detecting intervals of low energy or low posterior speech probability, and stores utterance section information in a database.

The server performs natural language processing on the recognized character data. The server uses a morphological analyzer to segment the character data into tokens and assign part-of-speech tags. The server uses a syntactic parser to compute dependency relations between tokens, storing a tree or graph representation of grammatical structure. The server applies semantic analysis to identify predicates and arguments and to recognize expressions indicating emotions or internal states, such as words related to loneliness, anxiety, or joy. The server performs topic classification by applying, for example, a text classifier based on a transformer encoder neural network that has been fine-tuned on labeled utterances into categories such as health, family, sleep, hobbies, and memories. The server extracts conversation themes, utterance intentions, related concepts, and keywords and stores them in association with the corresponding utterance entries in a relational database.

The server manages user profile information in a profile management component. The server stores, for each user, attribute information including age, biological sex, and family status; preference information such as preferred topics or disliked topics represented as weights; health-related information; past conversation history including utterance texts and system outputs; and emotion history including time-stamped emotion vectors. The server maintains this information in a structured schema in a relational database management system. The server updates the profile information dynamically. When the server detects, for example, that a user frequently mentions gardening in positive emotional contexts, the server increases a preference score associated with a gardening topic. When the server detects that a user repeatedly expresses anxiety when referring to crowded places, the server sets a negative preference weight for corresponding topic labels. The server stores topic-emotion relationships as statistical associations, such as conditional probabilities or correlation coefficients, between topic labels and changes in specific emotion components.

The server estimates the user's emotion state using a multimodal emotion estimation model. The server computes acoustic feature quantities from the preprocessed digital audio data. The server uses an audio feature library to calculate, for each frame, Mel-frequency cepstral coefficients, spectral centroid, zero-crossing rate, energy, and an estimated fundamental frequency. The server aggregates frame-wise features to create utterance-level sequences and normalizes features by speaker-specific statistics.

In a visual embodiment, the terminal captures images of the user's face using the camera and sends compressed video frames to the server. The server uses an image processing library to detect face regions using a cascade classifier or a deep convolutional detector. The server detects facial landmarks and feeds cropped face images into a convolutional neural network trained to predict expression categories or facial action unit intensities. The server converts the outputs of the network into expression features, such as a vector of probabilities for neutral, happy, sad, or angry expressions.

The server encodes the text of each utterance using a language representation model, such as a bidirectional transformer encoder trained on text corpora. The server obtains sentence-level embeddings that capture semantic content. The server concatenates or otherwise fuses text embeddings, acoustic feature sequences, and expression features into a multimodal feature representation. The server passes this representation to an emotion estimation model implemented as a deep neural network, such as a recurrent neural network with gated recurrent units or a transformer-based sequence model, which outputs a multidimensional emotion vector indicating intensities of components such as joy, relief, anxiety, loneliness, anger, and boredom. The server also applies a time-series model to a sequence of past emotion vectors to compute temporal change tendencies, such as an increasing trend in loneliness over several days.

In one learning configuration, the server trains the emotion estimation model offline on annotated multimodal corpora. The server defines a loss function such as mean squared error between predicted emotion component values and ground truth annotations. The server updates network weights using an optimization method such as stochastic gradient descent with adaptive learning rate. The server may perform data augmentation by adding noise to audio signals, randomly masking tokens in text, or applying small geometric transformations to face images, to improve robustness. By using multimodal input and temporal modeling, the server achieves higher accuracy in emotion estimation than purely text-based or purely acoustic methods. This directly improves downstream decisions including topic selection and timing control.

The server generates a prompt sentence for a generative AI model. The server retrieves, for the current user, recent conversation history, profile information, and current and recent emotion states. The server summarizes the recent conversation content using either rule-based extraction of key sentences or a summarization model constructed with a neural encoder-decoder architecture. The server selects salient items such as frequently recurring topics and explicit statements of difficulty or loneliness.

The server constructs a prompt sentence in natural language that encodes this information in a structured format. The server includes, for example, age, hobbies, family context, a brief summary of recent utterances, and quantified emotion state and trends. The server also includes explicit instructions to the generative AI model regarding its role, the desired output language, tone, and number of suggestions. An example of such a prompt sentence is:

“You are a conversational support AI assistant in a nursing care facility.

The target older adult has the following profile:
Age: 82, female
Hobbies: gardening, classical music (especially a certain composer), travel (for example, traditional cities)
Family: lives in a facility; her eldest child lives with a spouse and two grandchildren.

Summary of recent conversations:
In the past few days she has often said ‘I can't sleep well at night’ and ‘I feel a bit lonely.’ Her current emotional state is estimated as: loneliness: high, anxiety: medium, joy: low. Please propose three gentle conversation topics and initial questions that can ease her loneliness and anxiety, give a sense of security, and help her feel more positive.

Answer in Japanese, using polite form and short, easy to understand sentences for an older adult.”

The server passes this prompt sentence as input to a generative AI model. In one embodiment, the generative AI model is a large language model implemented as a transformer decoder network with multiple self-attention layers, trained on large scale text datasets. The server communicates with the generative AI model through an application programming interface over a network. The server specifies decoding parameters such as a maximum output length and a temperature controlling sampling diversity. The server receives one or more generated texts from the generative AI model, which include candidate conversation topics and corresponding utterance sentences.

The server evaluates the generated candidates using explicit scoring logic executed on the processor. The server applies natural language processing to each candidate to extract keywords and themes. The server compares these with preference information in the profile, computing a preference match score by summing or weighting matches between topic labels and high-weight preference entries. The server also evaluates emotional suitability by scanning for words or patterns that violate safety or sensitivity rules, such as references to distressing events when the user exhibits high anxiety. The server combines these measures into a suitability score for each candidate, for example by calculating a weighted sum of normalized preference and suitability values. The server selects at least one candidate with the highest suitability score as a conversation topic and utterance sentence to be used.

The server controls timing of presentation. The server analyzes utterance section information produced by the speech recognition engine, including start and end times of user utterances. The server computes silence durations as intervals between the end time of a last utterance and the current time. The server compares these durations with thresholds tuned for natural conversational rhythm. At the same time, the server inspects the latest emotion vector and trend. If the server detects high anger or high acute anxiety, the server delays introduction of a new topic and may instead favor a short empathic acknowledgement or silence. If the server detects sustained high loneliness or boredom, the server advances the timing to more quickly initiate a new conversation topic after a brief pause.

In a further embodiment, the server generates a second prompt sentence aimed at obtaining timing recommendation information from the generative AI model. The server assembles a short transcription of the last part of the conversation and the current emotion state and constructs a text such as:

“Below is the last 30 seconds of conversation between an older adult and a caregiver, and the estimated emotional state.
Conversation text: ‘Recently, at night I somehow feel lonely’ ‘I see. Is there anything in particular that worries you?’ ‘Not really anything in particular just somehow’
Current emotional state: loneliness high, anxiety medium, anger low, joy low.

You are an assistant that decides whether an AI should introduce a new topic now or keep a more empathic silence.

In this situation, choose exactly one of:
1) Introduce a new topic immediately.
2) Give only a short empathic comment and wait.
3) Stay silent for a while and just observe.

Output your choice and briefly explain the reason.”

The server sends this timing-support prompt sentence to the generative AI model, and receives recommendation information such as a selected option and an explanation. The server does not rely solely on this external recommendation but integrates it with internal timing rules implemented as algorithmic conditions on silence durations and emotion thresholds. By combining rule-based logic and learned textual reasoning, the server obtains more robust timing decisions than would be possible with fixed heuristics or human-designed scripts alone.

The server generates an audio signal for presentation using a speech synthesis module. The server uses a text-to-speech engine implemented as, for example, a statistical parametric synthesizer or a neural vocoder with an acoustic model that predicts mel-spectrograms from text and a waveform generator that reconstructs time-domain audio. The server selects speech parameters such as speaking rate, pitch, and voice quality based on the estimated emotion state. For a user exhibiting high loneliness and low joy, the server configures a slower speaking rate and a softer, warmer timbre. For a user exhibiting high alertness, the server may choose a slightly faster and brighter voice. The server generates a digital audio signal that encodes the selected utterance sentence and conforms to a playback format such as 16-bit PCM at a predetermined sampling rate. The server sends the synthesized audio along with playback timing instructions to the terminal.

The terminal receives the synthesized audio data and timing information. The terminal buffers the audio data in local memory and schedules playback through an audio output interface provided by the operating system. The terminal converts the digital audio samples to an analog signal through a digital-to-analog converter and drives the loudspeaker to emit sound into the room. The user hears the question or comment and responds naturally. In this manner, the system is not limited to abstract information processing but directly controls physical audio hardware to influence the user's environment.

The user interacts with the system without conscious operation. The user speaks, shows facial expressions, and performs gestures in a daily living environment. The system continuously acquires sensor data from microphones and, if present, cameras, and logs and analyzes this data. The server updates the profile information and emotion history as new interactions occur. Because the system integrates multimodal emotion estimation with dynamic profile updating and structured prompt sentence construction, the server achieves technical improvements compared with conventional systems that rely on static templates or simple keyword matching. Specifically, the integration enables more accurate selection of conversation topics and more precise timing, reducing unnecessary or inappropriate interventions and lowering overall error rates in dialog management decisions.

From a computer technology perspective, this architecture improves the internal operation of the computing system. The server uses data structures that index utterances by user ID, time, topic label, and emotion vector, enabling efficient retrieval and aggregation. The server uses dedicated feature stores to cache acoustic features and expression features, reducing redundant computation. The server uses streaming processing for audio input and incremental update of emotion states, which reduces latency compared with batch processing. The combination of rule-based selection and suitability scoring allows the server to filter outputs of a generative AI model and avoid re-generating candidates, thereby saving communication bandwidth and processing time.

The emotion estimation model and prompt generation logic implement processing methods that would be impractical for a human operator to execute manually in real time. For example, the server simultaneously evaluates dozens of emotion dimensions, correlates them with hundreds of topic labels over thousands of previous utterances, and encodes this structured state into a prompt sentence in a fraction of a second. The system applies consistent quantitative thresholds and optimization functions that are defined by explicit algorithms, rather than relying on subjective human judgment. This combination of automated feature extraction, multimodal fusion, and dynamic prompt sentence construction constitutes a specific, non-conventional way of using generative AI models that goes beyond simple automation of human conversation.

In alternative embodiments, the server executes all modules on a single physical machine, or distributes modules across multiple machines for scalability. In another embodiment, the generative AI model is hosted locally within the same data center rather than accessed as an external service. In still another embodiment, the emotion estimation model is simplified to use only acoustic and text features, while retaining the same data flow, or is extended to incorporate physiological signals if such sensors are available. In each case, the fundamental arrangement remains the same: the server acquires sensor-derived digital signals from the terminal, transforms them into structured linguistic and emotional representations, dynamically updates user profiles, constructs prompt sentences that encode this state, calls a generative AI model using these prompt sentences, filters and selects outputs based on suitability scores, determines output timing with reference to utterance section information and emotion states, and synthesizes and outputs audio signals through the terminal.

By structuring processing in this way, the system achieves technical advantages. The system increases the accuracy of emotion-aware topic selection, lowers latency in conversational responses, improves stability of dialog timing, and reduces misalignments between the user's emotional needs and system outputs. These improvements are realized through specific configurations of hardware and software modules and explicit data processing flows, rather than through abstract ideas alone.

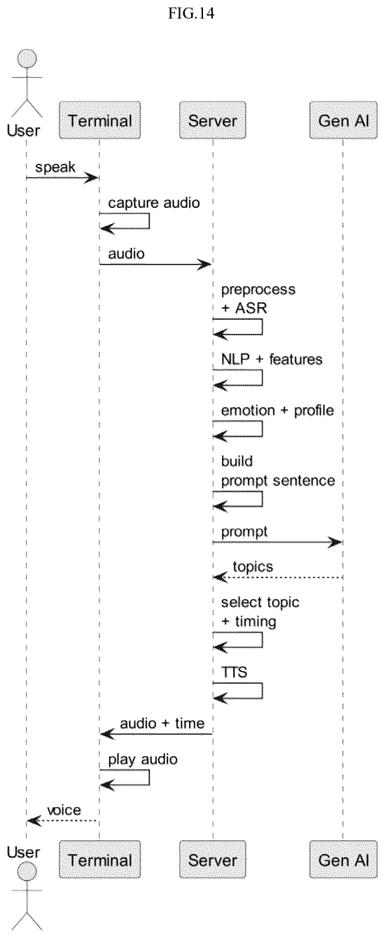

The following describes the processing flow using FIG. 14.

### Step 1:

The terminal acquires environmental audio.

The terminal uses a microphone and an analog-to-digital converter to capture an analog sound signal in the vicinity of the user. The input is a continuous analog waveform. The terminal samples this waveform at a predetermined sampling frequency and quantizes it at a predetermined bit depth to produce digital audio data. The terminal stores the resulting digital audio samples in an input buffer in main memory.

### Step 2:

The terminal performs local noise reduction and packetization.

The terminal reads buffered digital audio data as fixed-length frames (for example, 1-second segments). The input is a frame of raw digital audio samples. The terminal applies a lightweight noise reduction algorithm, such as frame-wise spectral subtraction, by computing a short-time Fourier transform, estimating a noise spectrum from non-speech segments, and attenuating spectral components dominated by noise. The terminal then repacks the denoised audio samples along with metadata including a terminal identifier, a user identifier if available, timestamps, and sequence numbers into a network packet. The output is a sequence of audio packets ready for transmission.

### Step 3:

The terminal transmits audio packets to the server.

The terminal uses a network interface and a communication protocol to send each audio packet to the server. The input is the packetized audio frame including payload and metadata.

The terminal opens a secure connection, attaches protocol headers, and writes the packet to the network socket. The output is the same audio packet delivered over the network to the server.

### Step 4:

The server receives and buffers audio data.

The server listens on a network port for incoming audio packets. The input is a network stream carrying audio packets from one or more terminals. The server validates protocol headers, extracts the audio payload and metadata, and stores the audio data in a per-user buffer structure in main memory, indexed by user identifier and timestamp. The output is a set of buffered, ordered digital audio frames associated with individual users.

### Step 5:

The server performs audio preprocessing and denoising.

The server fetches buffered frames for processing. The input is a sequence of digital audio frames for a given user. The server checks the sampling rate and channel configuration and, if needed, resamples or converts to a standard internal format such as single-channel 16 kHz PCM. The server then normalizes the audio amplitude to a target level by computing the root-mean-square value over the frame and applying a gain factor. For more advanced denoising, the server applies a deep learning-based denoiser by converting each frame to a magnitude spectrogram, passing it through a trained encoder-decoder network, and reconstructing a cleaned waveform. The output is preprocessed, noise-suppressed audio data ready for speech recognition and feature extraction.

### Step 6:

The server performs speech recognition and utterance segmentation.

The server inputs the preprocessed audio to a speech recognition engine. The input is continuous digital audio data with associated timestamps. The server computes acoustic features such as Mel-frequency cepstral coefficients over overlapping windows, feeds the feature sequence into an acoustic model (for example, a deep neural network), and decodes the most probable text sequence using a language model. The server also identifies speech and non-speech regions by measuring frame-wise speech posterior probabilities and marking low-probability regions as silence. The output is character data for each detected utterance, with start and end times and confidence scores, together with utterance section information indicating the positions of speech and silence.

### Step 7:

The server performs natural language processing on the recognized text.

The server retrieves newly recognized utterances. The input is a set of character strings with associated time information. The server tokenizes each string using a morphological analyzer, assigns part-of-speech tags, and builds dependency trees using a syntactic parser. The server then applies semantic analysis to identify predicates, arguments, and emotion-related expressions, and applies a topic classifier to assign category labels such as health, sleep, family, or hobbies. The output is an enriched representation of each utterance including tokens, part-of-speech tags, syntactic structure, topic labels, detected emotions in text, and extracted keywords.

### Step 8:

The server extracts acoustic features for emotion analysis.

The server processes the same audio segments used for recognition. The input is preprocessed audio aligned to utterance time ranges. The server divides each utterance into short overlapping frames, computes spectral features such as MFCCs, spectral centroid, and energy, and derives prosodic measures such as fundamental frequency, speaking rate, and pause length. The server organizes these numerical values into a time-series of feature vectors, optionally normalizing each feature dimension by the user's historical mean and variance. The output is an acoustic feature sequence associated with each utterance.

### Step 9:

The server extracts visual features when camera data is available.

The server receives image frames from the terminal. The input is a time-stamped sequence of compressed images containing the user's face. The server uses an image processing library to detect faces, crop the face region, and detect facial landmarks. The server passes the cropped faces through a trained facial expression classifier, which outputs probabilities for expression categories or scores for facial action units. The server converts these outputs into expression feature vectors and aligns them in time with corresponding utterances. The output is a sequence of visual feature vectors for each utterance.

### Step 10:

The server estimates the user's multidimensional emotion state.

The server aggregates textual, acoustic, and visual features. The input is, for each utterance, a text embedding from a language representation model, an acoustic feature sequence, and, when available, an expression feature sequence. The server concatenates or fuses these features and feeds them into a multimodal emotion estimation model, such as a recurrent neural network or transformer. The model computes a vector of emotion component values, including intensities for joy, relief, anxiety, loneliness, anger, and boredom. The server also inputs a sequence of past emotion vectors into a time-series model to derive temporal change tendencies such as increasing loneliness. The output is a current emotion vector and trend indicators for the user, associated with the latest utterance.

### Step 11:

The server updates the user profile based on new analysis.

The server queries the profile database. The input is a user identifier, current conversation themes, extracted keywords, and newly estimated emotion information. The server reads existing attribute information, preference information, health-related information, and past topic-emotion relationships. The server then adjusts preference scores by, for example, increasing weights for topics that co-occur with positive emotion changes and decreasing weights for topics that co-occur with negative emotion changes. The server updates stored topic-emotion correlations by recomputing statistical measures across an extended history that now includes the latest interaction. The output is an updated profile record stored back into the database.

### Step 12:

The server generates a prompt sentence for a generative AI model.

The server constructs an instruction text for topic generation. The input is the updated user profile, recent conversation history, and the current emotion vector and trends. The server summarizes recent utterances into a short description, selects key preferences and constraints such as age, hobbies, and family context, and encodes the current emotion state in descriptive terms. The server then assembles a natural language instruction that describes the target user, outlines recent issues, specifies the desired tone of the response, and requests a specified number of candidate topics and questions. The output is a complete prompt sentence ready to be supplied to a generative AI model.

### Step 13:

The server requests candidate conversation topics from the generative AI model.

The server communicates with a language generation service. The input is the prompt sentence constructed in the previous step. The server sends this text to the generative AI model through an application programming interface, specifying generation parameters such as maximum length and sampling temperature. The generative AI model produces text completions containing multiple candidate conversation topics and associated question sentences. The server receives the generated text, parses it into individual candidates, and stores them for further evaluation. The output is a collection of candidate conversation topics and utterance sentences represented as text.

### Step 14:

The server evaluates and selects suitable conversation topics.

The server assesses each candidate against user-specific criteria. The input is the list of candidate topics and questions, the current user profile, and the current emotion state. The server applies natural language processing to each candidate to extract topic labels and keywords. The server computes a preference match score by comparing extracted topics with preference weights in the profile, and computes an emotional suitability score by checking for terms that might be inappropriate given the current emotion vector. The server combines these scores, for example by a weighted sum or learned ranking function, to obtain a suitability score for each candidate. The output is at least one selected conversation topic and utterance sentence with the highest suitability score.

### Step 15:

The server determines an appropriate timing for presenting the selected topic.

The server examines the conversational timing context. The input is the utterance section information from speech recognition, including start and end times of recent utterances, the computed silence durations, the current emotion state and trends, and the selected topic and sentence. The server calculates the length of the ongoing silence and compares it with thresholds defining natural pauses. The server then modulates these thresholds based on emotion, for example extending the delay when anger is high or shortening it when loneliness is high. Optionally, the server constructs a timing-support prompt sentence containing the latest dialogue transcription and emotion state, and sends it to the generative AI model to receive timing recommendation information. The server integrates any recommendation with internal timing rules to decide whether to speak now, delay, or issue only a brief empathic comment. The output is a decision containing a scheduled presentation time and the type of utterance to output.

### Step 16:

The server synthesizes speech for the selected utterance.

The server prepares the text for output. The input is the selected utterance sentence and the scheduled presentation time, along with the current emotion vector. The server chooses speech synthesis parameters such as voice type, speaking rate, pitch, and volume based on the emotion state, for example slower and softer for high loneliness. The server calls a text-to-speech engine, which converts the text into a phoneme sequence, predicts an acoustic representation such as a mel-spectrogram, and generates a time-domain waveform. The output is a segment of synthesized audio in a standard playback format and associated metadata including the planned start time.

### Step 17:

The server sends synthesized audio and control information to the terminal.

The server prepares a playback instruction. The input is the synthesized audio data and timing metadata. The server packetizes the audio into network messages and attaches control information specifying when and how the terminal should play the audio. The server transmits these packets over the network to the terminal. The output is a stream of audio packets and commands delivered to the terminal.

### Step 18:

The terminal plays back the synthesized audio to the user.

The terminal receives the audio packets and instructions. The input is the audio payload and the scheduled start time. The terminal buffers the audio in local memory, configures the audio output channel through the operating system, and waits until the specified time. When the start time is reached, the terminal feeds the audio samples to a digital-to-analog converter and drives the loudspeaker to emit the synthesized voice. The output is physical sound in the user's environment conveying the selected conversation topic and question.

### Step 19:

The user listens and responds, closing the loop.

The user hears the voice output from the terminal and understands the question or comment.

The input to the user is the acoustic stimulus generated by the system. The user produces a natural response, such as answering a question about past experiences or expressing current feelings. The user's response becomes new environmental sound. The output from the user is a new spoken utterance, and, in some cases, accompanying facial expressions or gestures. This new behavior is again captured by the terminal microphone and camera, and the system returns to Step 1 to process the new data, thereby continuously updating profiles, emotion states, prompt sentences, and generated conversation topics.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

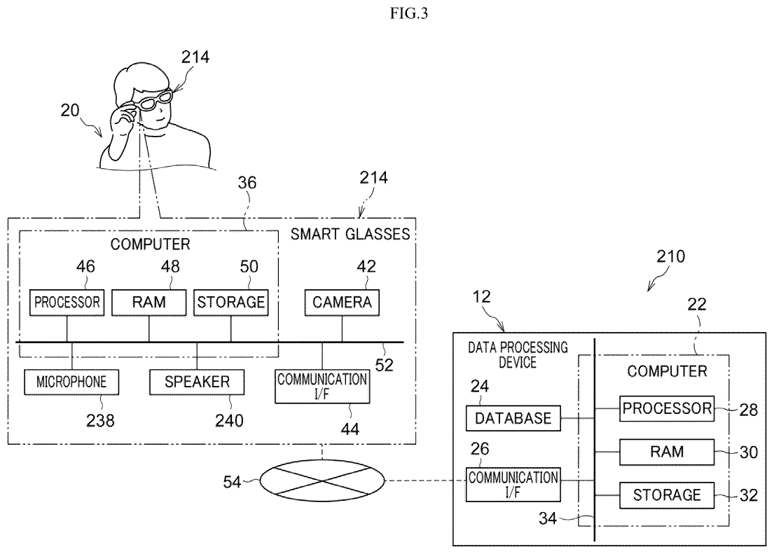

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

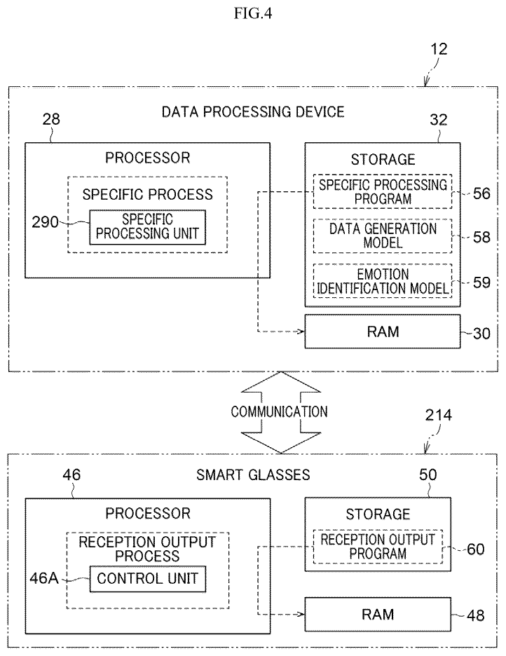

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

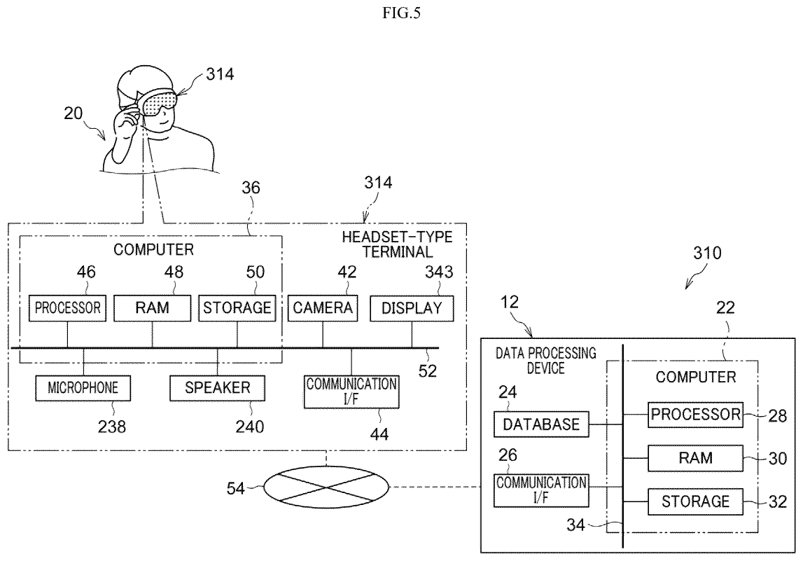

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

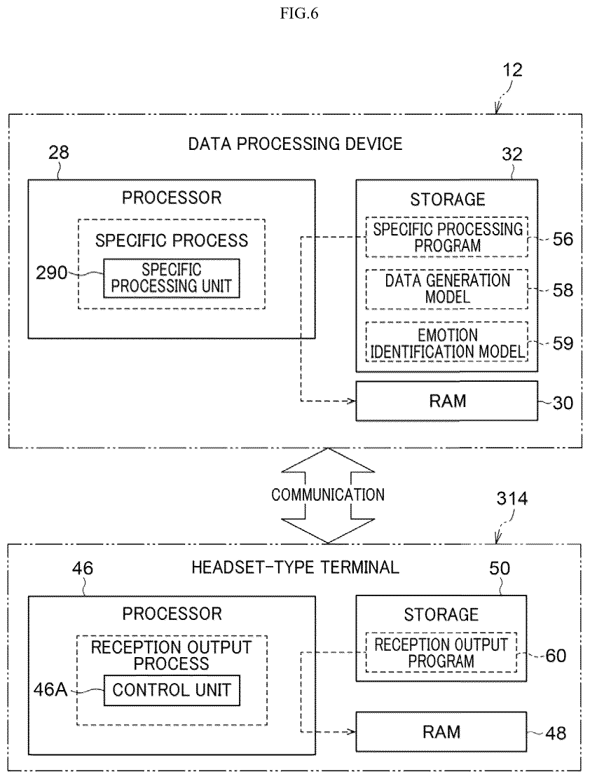

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

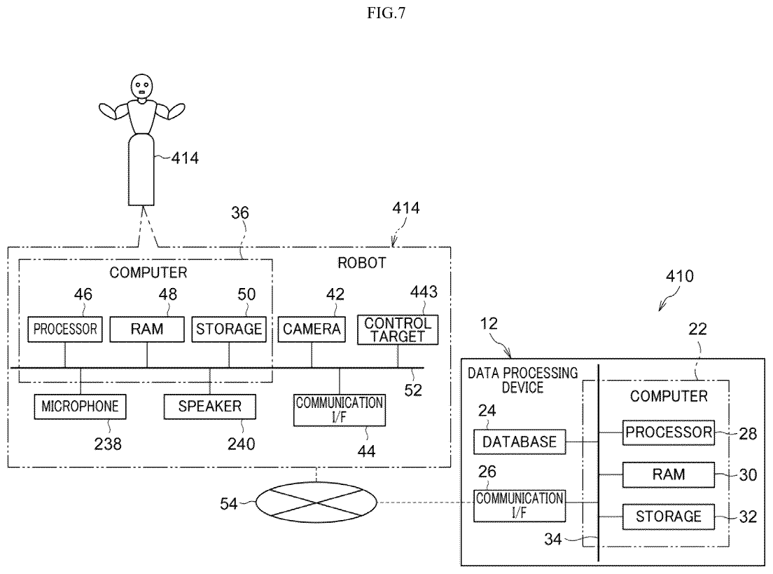

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

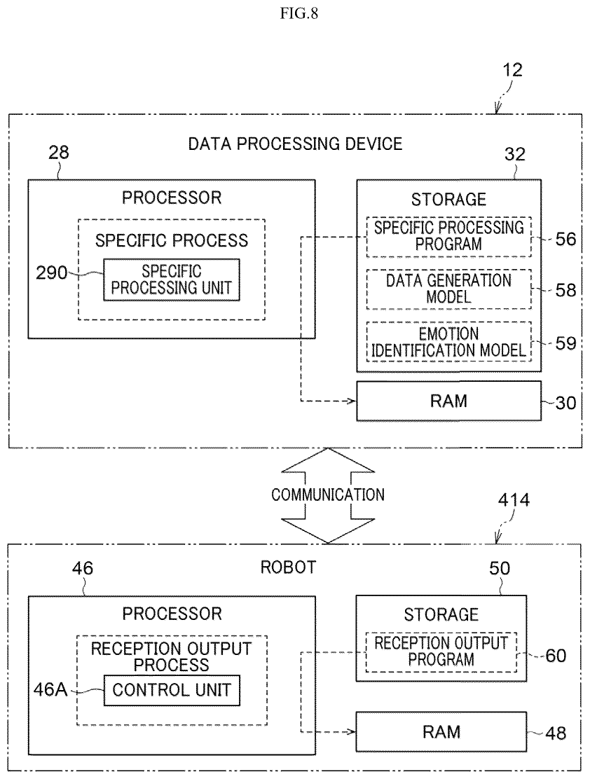

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

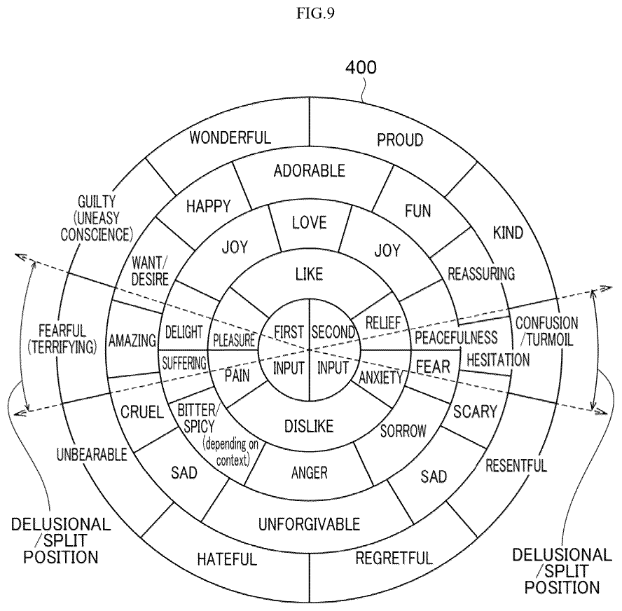

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

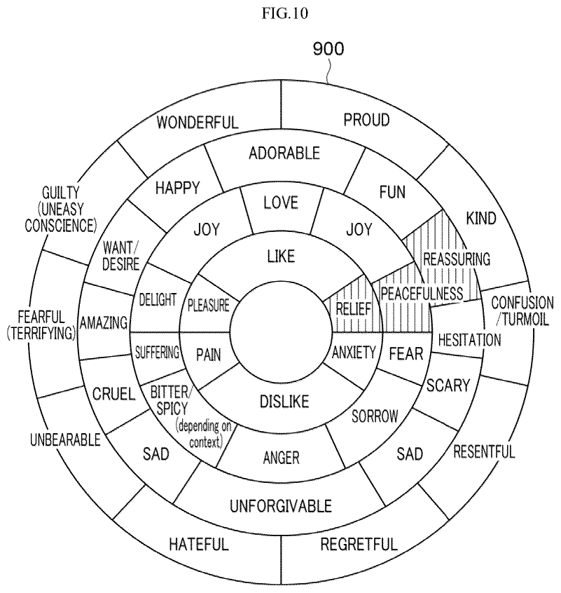

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire conversation audio from an environment by using an input apparatus including an audio sensor, divide the acquired conversation audio into time-based segments, and transmit the time-based segments via a communication path,
receive the time-based segments via the communication path and perform speech recognition processing on the time-based segments to convert the conversation audio into character information,
perform natural language processing on the character information to generate utterance units and conversation intervals, and to extract part-of-speech information, syntactic information, and semantic information,
classify, based on a result of the natural language processing, a conversation topic, a speaker intention, and an emotional state, and generate, for each conversation interval, a topic information vector and an emotion information vector,
store, in a storage apparatus, a user information set including interest information, preference information, personality information, liking information, and behavior history information regarding a user, and update and manage the user information set,
calculate a similarity between the topic information vector of the conversation and an interest information vector obtained from the user information set, and extract, based on the similarity, an effective interest target for the user,
generate, based on context information including character information of the conversation interval, the conversation topic, the speaker intention, the emotional state, and the effective interest target, a prompt sentence for input to a generative AI model,
operate the generative AI model by using the prompt sentence and generate a plurality of conversation candidate sentences that the user can utter in the conversation,
determine, for each of the conversation candidate sentences, content suitability and safety, and select and rank the conversation candidate sentences based on the context information and the user information set,
analyze, based on utterance time information, silence interval information, speaker change information, and emotional variation information obtained from the conversation audio, a temporal flow of the conversation and determine an intervention time at which the conversation candidate sentences are to be presented by performing timing control,
input, at the determined intervention time, a selected conversation candidate sentence into a speech synthesis apparatus and generate synthesized speech corresponding to the conversation candidate sentence, and
present the synthesized speech, via an output apparatus worn by the user, as audio perceptible only to the user.

### (Supplementary 2)

The system according to supplementary 1,
wherein the processor is configured to
generate the prompt sentence for the generative AI model by forming structured context information including latest character information of the conversation interval, past character information within a predetermined time, a plurality of interest targets extracted from the user information set, and expression style information indicating a preferred speaking manner and tone of the user, and to create the prompt sentence including a role instruction for the generative AI model, an output format instruction, and a length constraint instruction based on the structured context information.

### (Supplementary 3)

The system according to supplementary 1,
wherein the processor is configured to
classify a conversation state by using, as feature quantities, a silence duration, an utterance length, an utterance frequency, a variation amount of an emotion score, and an occurrence of a specific term obtained from the conversation audio or the character information, determine, according to the classified conversation state, whether the conversation candidate sentence is presentable and a presentation priority of the conversation candidate sentence, and, when necessary, input a prompt sentence including the character information of the conversation interval and the feature quantities into the generative AI model to obtain a judgment result regarding intervention appropriateness, and correct the intervention time based on the judgment result.

### Application Example 1

### (Supplementary 1)

A system comprising a processor,
wherein the processor is configured to
acquire audio information representing ambient sound by using an audio information acquisition unit that captures surrounding sound in real time,
convert the acquired audio information into language information by using an audio information conversion unit that performs speech recognition,
analyze the language information by using a language information analysis unit that extracts topic information, emotion information, and intent information from the language information,
manage user attribute information, preference information, and conversation history information by using an attribute information management unit that stores the user attribute information, the preference information, and the conversation history information in a profile database and updates at least one of the user attribute information, the preference information, and the conversation history information in accordance with an analysis result obtained by the language information analysis unit,
generate conversation candidate information by using a conversation candidate information generation unit that automatically generates a prompt sentence to be input to a generative AI model based on the analysis result obtained by the language information analysis unit and the user attribute information managed by the attribute information management unit, inputs the prompt sentence to the generative AI model, and obtains, from the generative AI model, the conversation candidate information corresponding to the prompt sentence,
determine a presentation timing for the conversation candidate information by using a presentation timing determination unit that calculates, based on time information, silence information, voice intensity information, and utterance boundary information relating to a progress state of a conversation, at least one of a time and an order for presenting the conversation candidate information, and
output audio based on the conversation candidate information by using an audio output unit that converts the conversation candidate information generated by the conversation candidate information generation unit into an audio signal and outputs the audio signal in accordance with the presentation timing determined by the presentation timing determination unit.

### (Supplementary 2)

The system according to supplementary 1,
wherein the processor is configured to
cause the conversation candidate information generation unit to automatically generate, as the prompt sentence, a text that integrates a latest analysis result of conversation content obtained by the language information analysis unit and user profile information managed by the attribute information management unit, add to the prompt sentence at least one constraint relating to a writing style, a length, and a prohibited content of an output sentence, and input the prompt sentence with the at least one constraint to the generative AI model so as to generate conversation candidate information adapted to a state and a preference of a user.

### (Supplementary 3)

The system according to supplementary 1,
wherein the processor is configured to
cause the presentation timing determination unit to quantify at least one of a silence duration indicating a boundary of the conversation, a linguistic expression indicating a topic change, and a reaction amount of the user based on the time information obtained from the audio information conversion unit and the emotion information obtained from the language information analysis unit, and to calculate, by using a control logic based on a quantification result, a timing for presenting the conversation candidate information obtained from the generative AI model.

### Example 2

### (Supplementary 1)

A system comprising a processor,
wherein the processor is configured to
acquire acoustic information representing surrounding speech by using an audio input unit, and convert the acoustic information into character information by using a speech recognition unit,
analyze the character information by using a natural language processing unit to perform lexical analysis, syntactic analysis, semantic analysis, and emotion analysis, and extract topic information of a conversation and linguistic emotion information,
store user attribute information including at least interest fields of a user, preference information, past conversation history, and preferred output style in a storage unit, and read and update the user attribute information in association with an analysis result of the natural language processing unit by using a user profile management unit,
input, to a multimodal emotion recognition model, at least one of acoustic feature quantities based on the acoustic information, language feature quantities based on the character information, and biological feature quantities based on biological information acquired from a biological measurement apparatus, and estimate an emotional state of the user and of at least one conversation participant by using an emotion estimation unit,
generate, by using a prompt generation unit, a prompt sentence including an instruction sentence and condition information for a generative artificial intelligence model, the prompt sentence being dynamically constructed based on the topic information and linguistic emotion information from the natural language processing unit, the user attribute information from the user profile management unit, and the emotional state from the emotion estimation unit,
execute, by using a conversation seed generation unit, the generative artificial intelligence model for natural language generation, using the prompt sentence as input, and generate at least one conversation seed including at least one of a topic suggestion sentence, a question sentence, and an introduction sentence for use by the user in a conversation,
determine, by using a timing control unit, a point in time or a time interval for presenting the conversation seed to the user, based on at least one of conversation text data from the natural language processing unit, the user attribute information from the user profile management unit, the emotional state from the emotion estimation unit, and, when necessary, a timing-evaluation prompt sentence for the generative artificial intelligence model,
and generate, by using a speech synthesis unit, speech synthesis text data in which speech parameters including at least speaking rate, pitch, and prosody are set based on the conversation seed generated by the conversation seed generation unit, a preferred speech characteristic included in the user attribute information from the user profile management unit, and the emotional state from the emotion estimation unit, generate audio data from the speech synthesis text data by using a speech synthesis device, and output the audio data to a terminal carried or worn by the user.

### (Supplementary 2)

The system according to supplementary 1,
wherein the processor is configured to
execute, by using the prompt generation unit, a summarization process on recent conversation text data to generate conversation summary information,
construct the prompt sentence by including the conversation summary information, a topic category estimated by the natural language processing unit, the interest fields and preference information obtained from the user profile management unit, and the emotional state estimated by the emotion estimation unit,
and execute, by using the conversation seed generation unit, an evaluation process on a plurality of conversation seed candidates obtained as output in response to the prompt sentence, the evaluation process including at least determining presence or absence of inappropriate expressions, evaluating degree of conformity with the topic, and evaluating degree of match with the user's interests, and selecting, based on a result of the evaluation process, at least one conversation seed to be presented.

### (Supplementary 3)

The system according to supplementary 1,
wherein the processor is configured to
analyze, by using the timing control unit, at least one of an utterance interval, a silence duration, and a degree of liveliness in the conversation indicated by the conversation text data, and a temporal change of at least one of a tension level, an anxiety level, and a positive emotion level of the user indicated by the emotional state estimated by the emotion estimation unit,
select a presentation timing of the conversation seed from among at least an immediate presentation, a presentation after a predetermined delay, and a non-presentation,
and record, as part of the user attribute information managed by the user profile management unit, an association among the conversation seed, the selected presentation timing, and a subsequent change in the emotional state estimated by the emotion estimation unit, and perform a learning process that reflects the association in at least one of a subsequent generation of the prompt sentence and a subsequent selection of the conversation seed.

### Application Example 2

### (Supplementary 1)

A system comprising a processor,
wherein the processor is configured to
acquire environmental sound through an audio input unit, convert an analog audio signal into digital audio data at a predetermined sampling frequency and bit depth, and perform preprocessing and noise suppression on the digital audio data,
calculate acoustic feature quantities from the digital audio data,
apply a speech recognition algorithm to the digital audio data to generate character data with time information and utterance section information,
perform natural language processing including morphological analysis, syntactic analysis, semantic analysis, and topic classification on the character data to extract conversation themes, utterance intentions, related concepts, and keywords,
store, for each user, profile information including attribute information, preference information, health state information, past conversation history, and emotion state history, and update the preference information and relationships between topics and emotions dynamically on the basis of analysis results from the natural language processing and the emotion state history,
input the acoustic feature quantities and the character data, and, when available, expression feature quantities extracted from image information or motion information, into an emotion estimation model, estimate a multidimensional emotion state and a temporal change tendency of the emotion state, and store estimation results in association with the profile information,
generate, on the basis of the profile information, analysis results of conversation content obtained by the natural language processing, and the estimated emotion state and the temporal change tendency of the emotion state, a prompt sentence in a natural language format as an instruction sentence to be input to a generative AI model,
call the generative AI model by using the prompt sentence as input, and cause the generative AI model to generate a plurality of conversation topic candidates and corresponding utterance sentences adapted to the profile information and the emotion state of the user,
evaluate, for each conversation topic candidate, a degree of suitability with respect to the profile information and the emotion state, and select at least one conversation topic and utterance sentence based on a score,
determine, on the basis of the utterance section information and silence time obtained by the speech recognition and the estimated emotion state, a time or time interval at which the selected conversation topic is to be presented, optionally generate an additional instruction sentence including recent conversation transcription and the emotion state, obtain recommendation information regarding timing from the generative AI model by using the additional instruction sentence, and control a presentation timing by integrating the recommendation information with internal rules,
and apply a speech synthesis algorithm to the selected utterance sentence and to speech parameters corresponding to the estimated emotion state to generate an audio signal for presentation to the user and to control an output device to output the audio signal at the determined presentation timing.

### (Supplementary 2)

The system according to supplementary 1,
wherein the processor is configured to
cooperate with the audio input unit and an acoustic preprocessing unit to process the audio signal acquired from the environment in real time, and to cause the natural language processing to perform high-accuracy syntactic analysis and topic classification on the character data so that the processor generates, by the prompt sentence generation, an instruction sentence including latest preference information in the user profile and the estimated emotion state, and causes the generative AI model to continuously generate conversation topics suited to an interest and an emotion state of the user.

### (Supplementary 3)

The system according to supplementary 1,
wherein the processor is configured to
calculate a length of a silence section from a start time and an end time of an utterance acquired by the speech recognition, determine a timing at which a conversation is judged to have reached a pause or a timing at which an empathic response is desirable by considering intensities and temporal change tendencies of emotion components including anxiety, loneliness, and joy estimated by the emotion estimation, transmit a timing-support instruction sentence to the generative AI model to obtain recommendation information regarding the timing from the generative AI model, and optimize, on the basis of a combination of the recommendation information and internal timing rules, a start time of output of synthesized speech generated by the speech synthesis.

What is claimed is:

1. A system comprising:
circuitry configured to:
acquire, via a communication interface coupled to a packet-switched network, audio sensor data representing ambient acoustic signals, divide the acquired audio sensor data into time-based segments, and perform speech recognition processing on the time-based segments to convert the audio sensor data into character information;
perform natural language processing on the character information to generate utterance units and conversation intervals, extract part-of-speech information, syntactic information, and semantic information, and classify a conversation topic, a speaker intention, and an emotional state for each conversation interval to generate a topic information vector and an emotion information vector;
store, in a memory, a user information set comprising interest information, preference information, personality information, and behavior history information regarding a user, calculate a similarity between the topic information vector and an interest information vector derived from the user information set, and extract an effective interest target for the user on the basis of the similarity;
generate, on the basis of context information comprising the character information of the conversation interval, the conversation topic, the speaker intention, the emotional state, and the effective interest target, a prompt sentence for input to a generative information processing model, transmit the prompt sentence to the generative information processing model, and receive a plurality of conversation candidate sentences from the generative information processing model;
determine content suitability for each of the conversation candidate sentences, and select and rank the conversation candidate sentences on the basis of the context information and the user information set;
analyze, on the basis of utterance time information, silence interval information, speaker change information, and emotional variation information obtained from the audio sensor data, a temporal flow of the conversation and determine an intervention time at which a selected conversation candidate sentence is to be presented; and
transmit the selected conversation candidate sentence to a client terminal via the packet-switched network.

2. The system according to claim 1, wherein the circuitry is configured to generate the prompt sentence by forming structured context information comprising latest character information of the conversation interval, past character information within a predetermined time period, a plurality of interest targets extracted from the user information set, and expression style information indicating a preferred speaking manner and tone of the user.

3. The system according to claim 2, wherein the circuitry is configured to include in the prompt sentence a role instruction for the generative information processing model, an output format instruction, and a length constraint instruction on the basis of the structured context information.

4. The system according to claim 3, wherein the circuitry is configured to add to the prompt sentence at least one constraint relating to a writing style, a prohibited content specification, and a length limitation, and to transmit the prompt sentence with the at least one constraint to the generative information processing model to generate conversation candidate sentences adapted to a state and a preference of the user.

5. The system according to claim 1, wherein the circuitry is configured to classify a conversation state by using, as feature quantities, a silence duration, an utterance length, an utterance frequency, a variation amount of an emotion score, and an occurrence of a specific term obtained from the audio sensor data or the character information, and to determine, according to the classified conversation state, whether the selected conversation candidate sentence is presentable and a presentation priority of the selected conversation candidate sentence.

6. The system according to claim 5, wherein the circuitry is configured to transmit a timing-evaluation prompt sentence comprising the character information of the conversation interval and the feature quantities to the generative information processing model, receive a judgment result regarding intervention appropriateness from the generative information processing model, and correct the intervention time on the basis of the judgment result.

7. The system according to claim 6, wherein the circuitry is configured to select a presentation timing from among at least an immediate presentation, a presentation after a predetermined delay, and a non-presentation, on the basis of the classified conversation state and the judgment result regarding intervention appropriateness.

8. The system according to claim 1, wherein the circuitry is configured to perform the natural language processing by executing morphological analysis, syntactic analysis, semantic analysis, and topic classification on the character information to extract the conversation topic, utterance intentions, related concepts, and keywords.

9. The system according to claim 1, wherein the circuitry is configured to input, to a multimodal emotion recognition model, at least one of acoustic feature quantities derived from the audio sensor data and language feature quantities derived from the character information, and to estimate a multidimensional emotion state comprising intensity values for a plurality of emotion categories and a temporal change tendency of the emotion state.

10. The system according to claim 9, wherein the circuitry is configured to generate the prompt sentence on the basis of the user information set, the conversation topic, and the estimated multidimensional emotion state and the temporal change tendency, so that the generative information processing model generates the conversation candidate sentences adapted to both the interest information and the emotional state of the user.

11. The system according to claim 10, wherein the circuitry is configured to determine the intervention time on the basis of the utterance time information and silence interval information obtained from the speech recognition processing and the estimated multidimensional emotion state, and to determine that an empathic response is desirable when intensities of emotion categories comprising anxiety and loneliness exceed predetermined thresholds.

12. The system according to claim 1, wherein the circuitry is configured to convert the acquired audio sensor data from an analog audio signal into digital audio data at a predetermined sampling frequency and bit depth, and to perform preprocessing comprising noise suppression on the digital audio data prior to the speech recognition processing.

13. The system according to claim 1, wherein the circuitry is configured to calculate acoustic feature quantities from the audio sensor data, the acoustic feature quantities comprising at least spectral envelope information, pitch information, and energy information, and to use the acoustic feature quantities as input to the classification of the emotional state.

14. The system according to claim 1, wherein the circuitry is configured to evaluate, for each of the plurality of conversation candidate sentences, a degree of suitability with respect to the user information set and the emotional state, calculate a score for each conversation candidate sentence, and select at least one conversation candidate sentence on the basis of the score.

15. The system according to claim 1, wherein the circuitry is configured to generate speech synthesis data on the basis of the selected conversation candidate sentence and speech parameters comprising at least a speaking rate, a pitch, and a prosody set on the basis of the emotional state and a preferred speech characteristic included in the user information set, and to transmit the speech synthesis data to the client terminal via the packet-switched network.

16. The system according to claim 1, wherein the circuitry is configured to record, in the memory, an association among the selected conversation candidate sentence, the intervention time, and a subsequent change in the emotional state, and to perform a learning process that reflects the association in at least one of a subsequent generation of the prompt sentence and a subsequent selection of the conversation candidate sentences.

17. The system according to claim 1, wherein the circuitry is configured to update the user information set by learning changes in the interest information and the preference information on the basis of the conversation topic and the emotional state extracted from the natural language processing, and to dynamically update the memory on the basis of the learned changes.

18. A system comprising:
a communication interface coupled to a packet-switched network;
a processor;
a random access memory; and
a non-volatile storage device storing a processing program, a speech recognition model, a natural language processing model, and a generative information processing model, wherein the processor executes the processing program loaded into the random access memory to:
acquire, via the communication interface, audio sensor data representing ambient acoustic signals, and perform speech recognition processing on the audio sensor data to convert the audio sensor data into character information;
perform natural language processing on the character information to extract a conversation topic, a speaker intention, and an emotional state, and generate a topic information vector and an emotion information vector;
store a user information set comprising interest information, preference information, and behavior history information in the non-volatile storage device, and calculate a similarity between the topic information vector and an interest information vector derived from the user information set;
generate a prompt sentence on the basis of context information comprising the conversation topic, the emotional state, and an effective interest target, transmit the prompt sentence to the generative information processing model, and receive a plurality of conversation candidate sentences;
determine an intervention time on the basis of utterance time information, silence interval information, and emotional variation information; and
transmit a selected conversation candidate sentence to a client terminal via the communication interface.

19. The system according to claim 18, wherein the processor is further configured to input acoustic feature quantities derived from the audio sensor data and language feature quantities derived from the character information into a multimodal emotion recognition model to estimate a multidimensional emotion state, and to include the multidimensional emotion state in the prompt sentence transmitted to the generative information processing model.

20. A method performed by circuitry of a system, the method comprising:
acquiring, via a communication interface coupled to a packet-switched network, audio sensor data representing ambient acoustic signals, dividing the acquired audio sensor data into time-based segments, and performing speech recognition processing on the time-based segments to convert the audio sensor data into character information;
performing natural language processing on the character information to generate utterance units and conversation intervals, extracting part-of-speech information, syntactic information, and semantic information, and classifying a conversation topic, a speaker intention, and an emotional state for each conversation interval to generate a topic information vector and an emotion information vector;
storing a user information set comprising interest information, preference information, personality information, and behavior history information, calculating a similarity between the topic information vector and an interest information vector derived from the user information set, and extracting an effective interest target on the basis of the similarity;
generating a prompt sentence on the basis of context information comprising the character information, the conversation topic, the speaker intention, the emotional state, and the effective interest target, transmitting the prompt sentence to a generative information processing model, and receiving a plurality of conversation candidate sentences;
determining content suitability for each of the conversation candidate sentences, and selecting and ranking the conversation candidate sentences;
analyzing a temporal flow of the conversation on the basis of utterance time information, silence interval information, speaker change information, and emotional variation information, and determining an intervention time; and
transmitting a selected conversation candidate sentence to a client terminal via the packet-switched network.
